(19) United States
(12) Patent Application Publication
(10) Pub. No.: US 2025/0018565 A1
(43) Pub. Date: Jan. 16, 2025

(54) APPARATUS, APPARATUS CONTROL METHOD, ARTICLE MANUFACTURING METHOD, APPARATUS ASSEMBLY METHOD, ROBOT, AUTOMOBILE, AND RECORDING MEDIUM

(71) Applicant: CANON KABUSHIKI KAISHA, Tokyo (JP)

(72) Inventors: AKIRA YAJIMA, Saitama (JP); ATSUO HONDA, Kanagawa (JP); TAKAYUKI OGAWARA, Kanagawa (JP); JUNICHI FUKUDA, Kanagawa (JP)

(21) Appl. No.: 18/762,462

(22) Filed: Jul. 2, 2024

(30) Foreign Application Priority Data
Jul. 12, 2023 (JP) 2023-114780
Jun. 6, 2024 (JP) 2024-092622

(51) Int. Cl. B25J 9/16; B25J 9/10; B25J 19/00

(52) U.S. Cl. CPC B25J 9/1635; B25J 9/108; B25J 19/0004

(57) ABSTRACT

An apparatus includes a support having two portions, and a unit including a speed reducer, a motor provided on the speed reducer, and a bearing provided on the speed reducer, the speed reducer, the motor, and the bearing being integrally assembled with each other and mounted on the two portions.

### BACKGROUND OF THE INVENTION

### Field of the Invention

The present disclosure relates to a technology of an apparatus.

### Description of the Related Art

As an apparatus, for example, a plurality of mechanical components such as a motor, a speed reducer, and a bearing are arranged at a joint of a robot as disclosed in JP 2016-196054 A.

### SUMMARY OF THE INVENTION

According to a first aspect of the present disclosure, an apparatus includes a support having two portions, and a unit including a speed reducer, a motor provided on the speed reducer, and a bearing provided on the speed reducer, the speed reducer, the motor, and the bearing being integrally assembled with each other and mounted on the two portions.

According to a second aspect of the present disclosure, a method of assembling an apparatus including a support having two portions, the method including fixing a speed reducer and a motor to a first member such that the speed reducer and the motor are positioned, fixing the speed reducer and a bearing to a second member such that the speed reducer and the bearing are positioned, and supporting the first member and the bearing by the two portions of the support.

Further features of the present invention will become apparent from the following description of exemplary embodiments with reference to the attached drawings.

### BRIEF DESCRIPTION OF THE DRAWINGS

FIG. 1 is an explanatory view illustrating a configuration of a robot system according to a first embodiment.

FIG. 2 is a block diagram illustrating a control system of the robot system according to the first embodiment.

FIG. 3 is a cross-sectional view of a joint structure according to the first embodiment.

FIG. 4 is a cross-sectional view of a drive unit according to the first embodiment.

FIG. 5 is an exploded cross-sectional view of the drive unit according to the first embodiment.

FIG. 6A is an explanatory view of a method of assembling the drive unit of the first embodiment.

FIG. 6B is an explanatory view of the method of assembling the drive unit of the first embodiment.

FIG. 7A is an explanatory view of the method of assembling the drive unit of the first embodiment.

FIG. 7B is an explanatory view of the method of assembling the drive unit of the first embodiment.

FIG. 8A is an explanatory view of the method of assembling the drive unit of the first embodiment.

FIG. 8B is an explanatory view of the method of assembling the drive unit of the first embodiment.

FIG. 9A is an explanatory view of the method of assembling the drive unit of the first embodiment.

FIG. 9B is an explanatory view of the method of assembling the drive unit of the first embodiment.

FIG. 10A is an explanatory view of the method of assembling the drive unit of the first embodiment.

FIG. 10B is an explanatory view of the method of assembling the drive unit of the first embodiment.

FIG. 11A is an explanatory view of the method of assembling the drive unit of the first embodiment.

FIG. 11B is an explanatory view of the method of assembling the drive unit of the first embodiment.

FIG. 12A is an explanatory view of the method of assembling the drive unit of the first embodiment.

FIG. 12B is an explanatory view of the method of assembling the drive unit of the first embodiment.

FIG. 13A is an explanatory view of the method of assembling the drive unit of the first embodiment.

FIG. 13B is an explanatory view of the method of assembling the drive unit of the first embodiment.

FIG. 14A is an explanatory view of the method of assembling the drive unit of the first embodiment.

FIG. 14B is an explanatory view of the method of assembling the drive unit of the first embodiment.

FIG. 15A is an explanatory view of the method of assembling the drive unit of the first embodiment.

FIG. 15B is an explanatory view of the method of assembling the drive unit of the first embodiment.

FIG. 16A is an explanatory view of the method of assembling the drive unit of the first embodiment.

FIG. 16B is an explanatory view of the method of assembling the drive unit of the first embodiment.

FIG. 17 is an explanatory view of a method of assembling a joint of the robot according to the first embodiment.

FIG. 18A is a side view of a link according to the first embodiment.

FIG. 18B is a side view of the drive unit according to the first embodiment.

FIG. 19A is a perspective view of the link according to the first embodiment.

FIG. 19B is a side view of the link according to the first embodiment.

FIG. 19C is a cross-sectional view of the link according to the first embodiment.

FIG. 19D is an explanatory view of a method of manufacturing the link according to the first embodiment.

FIG. 20 is an explanatory view of a method of assembling a joint according to a first modified example.

FIG. 21 is an explanatory view of a joint structure according to a second modified example.

FIG. 22 is an explanatory view of a joint structure according to a third modified example.

FIG. 23 is an explanatory view of a joint structure according to a fourth modified example.

FIG. 24A is a side view of a link according to a fifth modified example.

FIG. 24B is a cross-sectional view of the link according to the fifth modified example.

FIG. 24C is an explanatory view of a method of manufacturing the link according to the fifth modified example.

FIG. 25 is a cross-sectional view of a link according to a seventh modified example.

FIG. 26 is an explanatory view of a joint structure of a comparative example.

FIG. 27 is a cross-sectional view of a drive structure of an automobile according to a second embodiment.

FIG. 28 is an explanatory view of a method of assembling the drive structure of the automobile according to the second embodiment.

FIG. 29 is a cross-sectional view of a drive structure of an automobile according to a third embodiment.

FIG. 30 is an explanatory view of a method of assembling the drive structure of the automobile according to the third embodiment.

### DESCRIPTION OF THE EMBODIMENTS

An apparatus has been required to operate with high reproducibility and high accuracy. For this reason, mechanical components disposed in the apparatus are required to be assembled to each other with high accuracy.

The present disclosure improves accuracy of an operation performed by an apparatus.

Hereinafter, exemplary embodiments of the present disclosure will be described in detail with reference to the drawings.

### First Embodiment

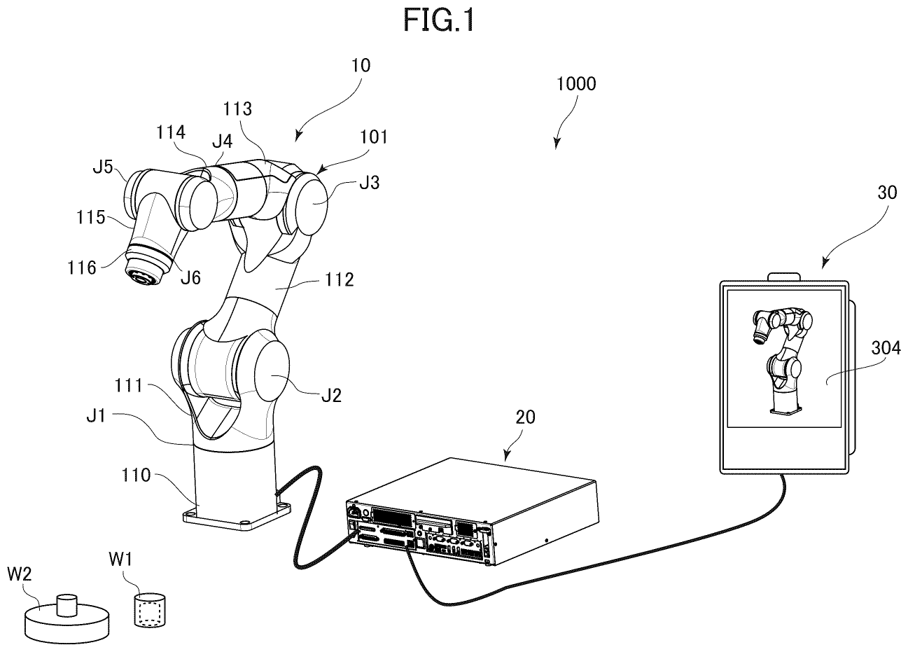

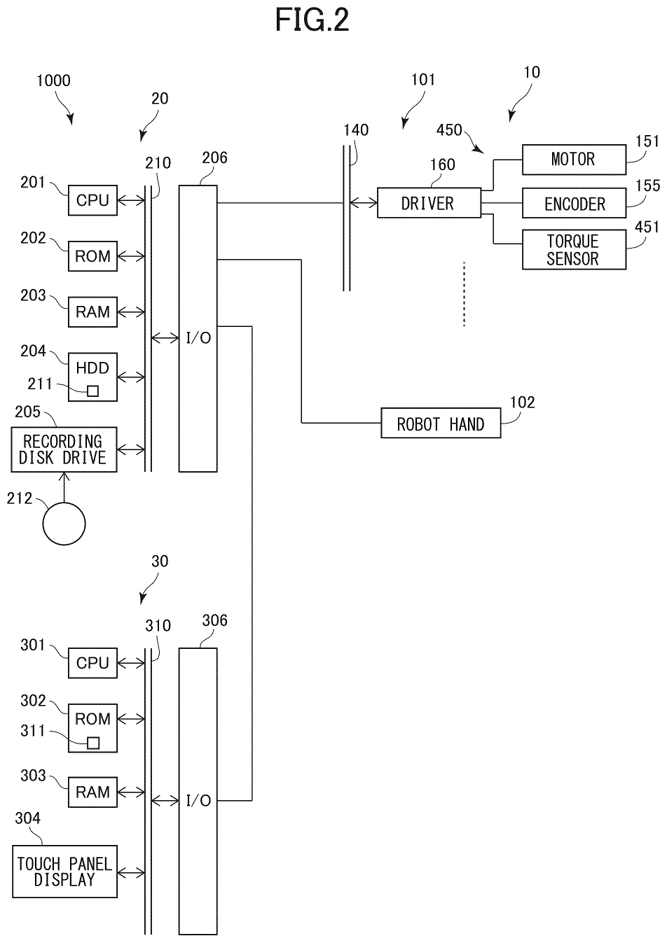

FIG. 1 is an explanatory view illustrating a configuration of a robot system 1000 according to a first embodiment. FIG. 2 is a block diagram illustrating a control system of the robot system 1000 according to the first embodiment. The robot system 1000 includes a robot 10, a control device 20, and a teaching pendant 30 that is an example of an operation device. The robot 10 is, for example, an industrial robot, and is a so-called manipulator. The robot 10 and the control device 20 are connected to each other by, for example, a cable so as to be able to transmit data. The control device 20 and the teaching pendant 30 are connected to each other by, for example, a cable so as to transmit data.

The control device 20 is for controlling an operation of the robot 10, and is implemented by, for example, a computer. The teaching pendant 30 is an input device operable by a user, has a function of transmitting an operation command to the control device 20 by being operated by the user, and can operate the robot 10 according to a user operation. The control device 20 is configured to operate the robot 10 according to an operation command of a robot program or an operation command from the teaching pendant 30.

A root of the robot 10 is a fixed end, and is fixed to a frame (not illustrated) or the like. A distal end of the robot 10 is a free end. The robot 10 includes a robot arm 101 and a robot hand 102 that is an example of an end effector attached to the robot arm 101. In FIG. 1, the robot hand 102 is not illustrated.

The robot arm 101 is a robot arm having six joints J1 to J6. The robot arm 101 is, for example, a vertically articulated robot arm. The number of joints is not limited to six, and may be seven, for example. The robot arm 101 includes a base 110 that is a fixed link and a plurality of links 111 to 116 that are movable links. The base 110 and the links 111 to 116 are connected by the joints J1 to J6, so that each of the links 111 to 116 is rotatable by each of the joints J1 to J6.

A motor serving as a drive source is disposed in each of the joints J1 to J6. When the motors provided in the joints J1 to J6 drive the joints J1 to J6, that is, the links 111 to 116, the robot 10 can take various postures. A tool center point (TCP) is defined at the distal end of the robot 10, and the robot 10 can be operated in various postures by designating a position and posture of the TCP. Each of the joints J1 to J6 is a rotary joint, but the present technology is not limited thereto, and for example, any joint may be a linear motion joint.

The robot hand 102 is configured to be able to hold a workpiece. In a production line for manufacturing an article, the robot 10 can hold the workpiece with the robot hand 102 to perform conveyance work, assembly work for assembling to another workpiece, and can hold a tool to perform processing work for the workpiece. Alternatively, the robot 10 can perform work by mounting an actuator other than the robot hand 102 on the link 116 according to a work content of a manufacturing process.

For example, workpieces W1 and W2 are arranged around the robot 10. By causing the robot 10 to hold the workpiece W1 and causing the robot 10 to assemble the workpiece W1 to the workpiece W2, an article as an assembly can be manufactured. The assembly may be an intermediate product or a final product. In a case where an article to be manufactured is a precision article, the robot 10 is required to perform highly accurate positioning control with high reproducibility.

The teaching pendant 30 includes an input unit that is an input device and a touch panel display 304 that also serves as a display unit that is a display device. A user interface (UI) image is displayed on the touch panel display 304. In the teaching pendant 30, the input unit and the display unit may be configured separately.

As illustrated in FIG. 2, the control device 20 is implemented by a computer, and includes a central processing unit (CPU) 201 that is a processor. In addition, the control device 20 includes a read only memory (ROM) 202, a random access memory (RAM) 203, and a hard disk drive (HDD) 204 as storage devices. In addition, the control device 20 includes a recording disk drive 205 and an input/output (I/O) 206 that is an input/output interface. The CPU 201, the ROM 202, the RAM 203, the HDD 204, the recording disk drive 205, and the I/O 206 are connected to each other via a bus 210 so as to be able to transmit data.

The ROM 202 stores a basic program read by the CPU 201 at the time of starting the computer. The RAM 203 is a transitory storage device used for arithmetic processing of the CPU 201. The HDD 204 is a storage device that stores various types of data such as an arithmetic processing result of the CPU 201. In the first embodiment, the HDD 204 stores a program 211 to be executed by the CPU 201. The CPU 201 controls the robot 10 by executing the program 211. The recording disk drive 205 can read various types of data, programs, and the like recorded in a recording disk 212. The robot arm 101, the robot hand 102, and the teaching pendant 30 are connected to the I/O 206.

The teaching pendant 30 is implemented by a computer and includes a CPU 301 that is a processor. The teaching pendant 30 includes a ROM 302 and a RAM 303 as storage devices. The teaching pendant 30 includes a touch panel display 304 and an I/O 306 as an input/output interface. The CPU 301, the ROM 302, the RAM 303, the touch panel display 304, and the I/O 306 are connected to each other via a bus 310 so as to be able to transmit data.

The ROM 302 stores a program 311 to be executed by the CPU 301. The CPU 301 executes a control method described below by executing the program 311. The RAM 303 is a transitory storage device used for arithmetic processing of the CPU 301. The I/O 306 is connected to the I/O 206 of the control device 20.

The robot arm 101 includes six drivers 160 corresponding to the joints J1 to J6 and six drive modules 450 corresponding to the joints J1 to J6. Each drive module 450 is disposed in each of the joints J1 to J6. FIG. 2 illustrates one of the six drivers 160 and one of the six drive modules 450.

Hereinafter, the joint J2 among the plurality of joints J1 to J6 will be described, and the other joints J1 and J3 to J6 have substantially the same configuration as the joint J2, and thus a description thereof will be omitted.

The drive module 450 includes a motor 151, an encoder 155, and a torque sensor 451. The driver 160 includes a microcomputer (not illustrated), an A/D conversion circuit (not illustrated), a motor drive circuit (not illustrated), and the like. The driver 160 is connected to the I/O 206 of the control device 20 via a bus 140.

The motor 151 is an electric motor and is a drive source that drives the joint J2. The motor 151 drives the distal end side link 112 of the two links 111 and 112 connected by the joint J2 with respect to the proximal end side link 111 via a transmission mechanism including a speed reducer described below.

The torque sensor 451 is an example of a force sensor that detects a force (torque) acting on the joint J2, that is, a force (torque) acting on the link 112 with respect to the link 111, and outputs a signal indicating a force value (torque value) that is a detection result to the driver 160. The encoder 155 is a rotary encoder, detects a rotation angle of a motor shaft of the motor 151, and outputs a signal indicating an encoder value that is a detection result to the driver 160.

The driver 160 takes in a signal from the torque sensor 451 at a predetermined cycle, converts the signal into a digital signal indicating the force value (torque value), and outputs the digital signal to the control device 20. Further, the driver 160 takes in and counts an encoder signal from the encoder 155, and outputs the counted value to the control device 20. The control device 20 controls the robot 10 based on the detection results.

In the first embodiment, a non-transitory computer-readable recording medium is the HDD 204, and the program 211 is stored in the HDD 204, but the present technology is not limited thereto. The program 211 may be recorded in any recording medium as long as the recording medium is a non-transitory computer-readable recording medium. For example, a flexible disk, a hard disk, an optical disk, a magneto-optical disk, a magnetic tape, a non-volatile memory, or the like can be used as the recording medium for storing the program 211.

In the first embodiment, the program 311 is stored in the ROM 302, but the present technology is not limited thereto. The program 311 may be recorded in any recording medium. For example, a flexible disk, a hard disk, an optical disk, a magneto-optical disk, a magnetic tape, a non-volatile memory, or the like can be used as the recording medium for storing the program 311.

In addition, the storage device included in the control device 20 is the HDD 204, but is not limited thereto, and the storage device included in the control device 20 may be, for example, a solid state drive (SSD). Similarly, the storage device included in the teaching pendant 30 is the ROM 302, but is not limited thereto, and the storage device included in the teaching pendant 30 may be an SSD.

The control device 20 or the teaching pendant 30 may be connected to a network. Furthermore, the robot 10 and the control device 20, or the control device 20 and the teaching pendant 30 may be connected by a network.

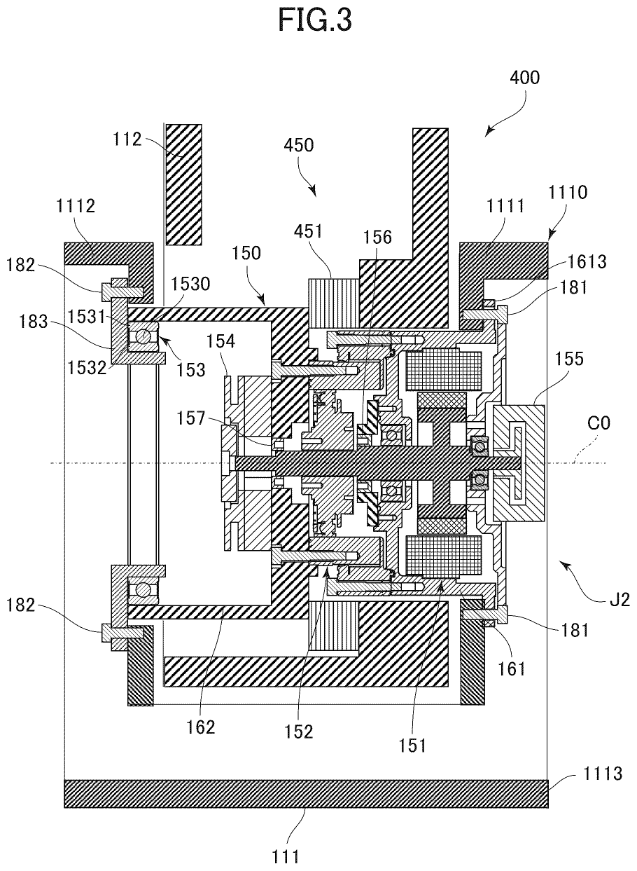

Hereinafter, a joint structure of the joint J2 will be described in detail. FIG. 3 is a cross-sectional view of a joint structure 400 according to the first embodiment. The joint structure 400 of the first embodiment includes the link 111, the link 112, and the drive module 450. The link 111 is an example of a support. Furthermore, the link 111 is an example of a first link, and the link 112 is an example of a second link.

The drive module 450 includes a drive unit 150 that is an example of a unit, and the torque sensor 451 that is an example of the force sensor. The drive unit 150 is supported by the link 111. The link 112 is supported by the drive unit 150 so as to be rotationally driven about an axis C0 by the drive unit 150 with respect to the link 111.

The drive unit 150 includes the motor 151, a speed reducer 152, and a bearing 153. The motor 151 is provided on an input side of the speed reducer 152, and the bearing 153 is provided on an output side of the speed reducer 152. The motor 151 is a drive source of the joint J2, and drives the link 112 via the speed reducer 152. The bearing 153 is disposed between the link 111 and the drive unit 150. The speed reducer 152 is preferably, for example, a wave gearing speed reducer. The bearing 153 is, for example, a cross roller bearing, and includes a plurality of rollers 1530, an outer ring 1531, and an inner ring 1532. The bearing 153 is not limited to this configuration. For example, the bearing 153 may be a sliding bearing such as a deep groove ball bearing, a needle-shaped roller bearing, a rolling bearing, a radial ball bearing, a radial roller bearing, or an oil-free bearing.

In the first embodiment, the inner ring 1532 of the bearing 153 is disposed to face the link 111, and the outer ring 1531 of the bearing 153 is disposed to face the drive unit 150. The motor 151, the speed reducer 152, and the bearing 153 become frictional resistance when axes thereof are misaligned from each other. Therefore, in order to cause the robot 10 to perform precise work, it is required to position the motor 151, the speed reducer 152, and the bearing 153 with high accuracy, that is, to align the axes of the motor 151, the speed reducer 152, and the bearing 153 with each other.

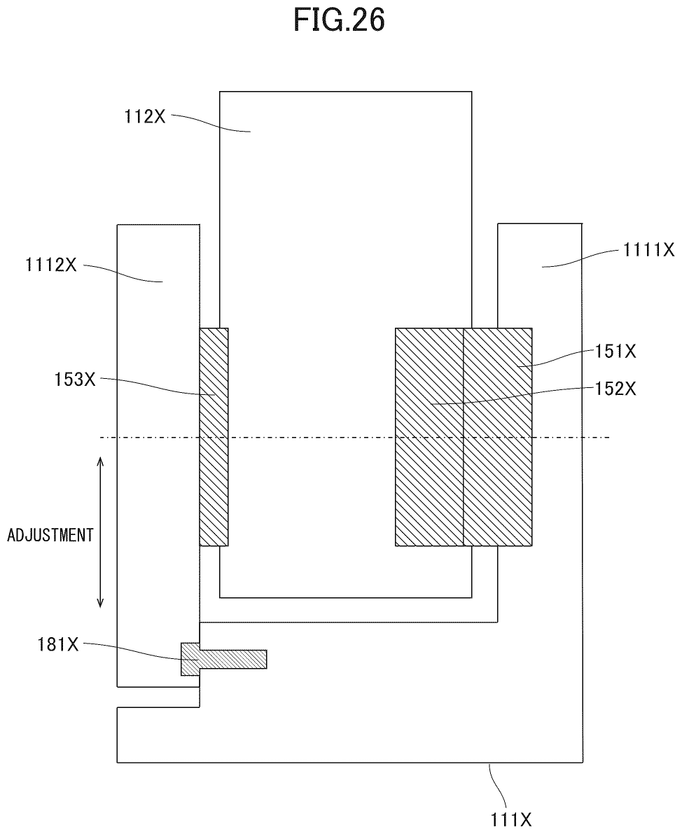

FIG. 26 is an explanatory diagram of a joint structure of a comparative example. A link 112X is rotationally driven by a motor 151X with respect to a link 111X via a speed reducer 152X. The link 111X includes two members (portions) 1111X and 1112X, and a U-shaped portion is formed by fastening the member 1111X to the member 1112X with a fastening member 181X. The motor 151X and the speed reducer 152X are positioned at and fixed to the member 1111X, and a bearing 153X is positioned at and fixed to the member 1112X. When adjusting axial positions of the motor 151X, the speed reducer 152X, and the bearing 153X, the member 1112X is moved in a direction orthogonal to the axis with respect to the member 1111X. After the axial positions are adjusted, the fastening member 181X is fastened in a direction parallel to the axis to fix the member 1112X to the member 1111X. In this manner, by sliding the member 1112X with respect to the member 1111X, the motor 151X, the speed reducer 152X, and the bearing 153X can be adjusted to be axially aligned. However, the member 1111X needs to be provided with an adjustment margin in an adjustment direction, and the link 111X is required to have high stiffness. For this reason, it is necessary to make a fastening portion of the member 1111X of the link 111X thick in the adjustment direction. As a result, in the joint structure of the comparative example, the link 111X, that is, the robot, increases in size and weight.

The link 111 of the first embodiment has a U-shaped portion 1110 having a U shape. The drive module 450 is disposed in the U-shaped portion 1110. That is, the drive unit 150 and the torque sensor 451 are disposed in the U-shaped portion 1110. The torque sensor 451 is disposed between the drive unit 150 and the link 112 so that a torque acting on the link 112 with respect to the link 111 can be detected.

The motor 151, the speed reducer 152, and the bearing 153 are integrally assembled with each other via a plurality of members to be unitized. As a result, the motor 151, the speed reducer 152, and the bearing 153 are unitized (that is, integrated) while being axially aligned with each other. The motor 151, the speed reducer 152, and the bearing 153 may be unitized before the motor 151, the speed reducer 152, and the bearing 153 are mounted on the link 111, or may be unitized while being mounted on the link 111, that is, while the drive unit 150 is fixed to the link 111.

In the first embodiment, the drive unit 150 is mounted on the U-shaped portion 1110 so as to be integrally detachable from the U-shaped portion 1110 of the link 111. In other words, the drive unit 150 is unitized, that is, integrated, and attached to the link 111 so as to be detachable from the link 111 in an integrated state.

As described above, in the first embodiment, the motor 151, the speed reducer 152, and the bearing 153 can be axially aligned when the drive unit 150 is assembled, and it is not necessary to perform axial alignment with the link 111X as in the comparative example. Therefore, it is not necessary to increase the size and weight of the link 111 unlike the link 111X of the comparative example, the link 111 can be reduced in size and weight, and the motor 151, the speed reducer 152, and the bearing 153 can be axially aligned with high accuracy. Therefore, it is possible to cause the robot 10 to perform highly accurate positioning control with high reproducibility. In the first embodiment, the link 111 is integrally molded. Therefore, it is possible to reduce the size and weight of the link 111 while securing stiffness necessary for the link 111. Then, it is sufficient if the drive unit 150 including the motor 151, the speed reducer 152, and the bearing 153 that are axially aligned is mounted on the link 111. As the motor 151, the speed reducer 152, and the bearing 153 are axially aligned, performance and durability of the motor 151, the speed reducer 152, and the bearing 153 can be improved. In addition, frictional resistance caused by axial misalignment of the motor 151, the speed reducer 152, and the bearing 153 can be reduced, and positioning control of the robot 10 can be performed with high accuracy. That is, it is possible to cause the robot 10 to perform highly accurate operation with high reproducibility.

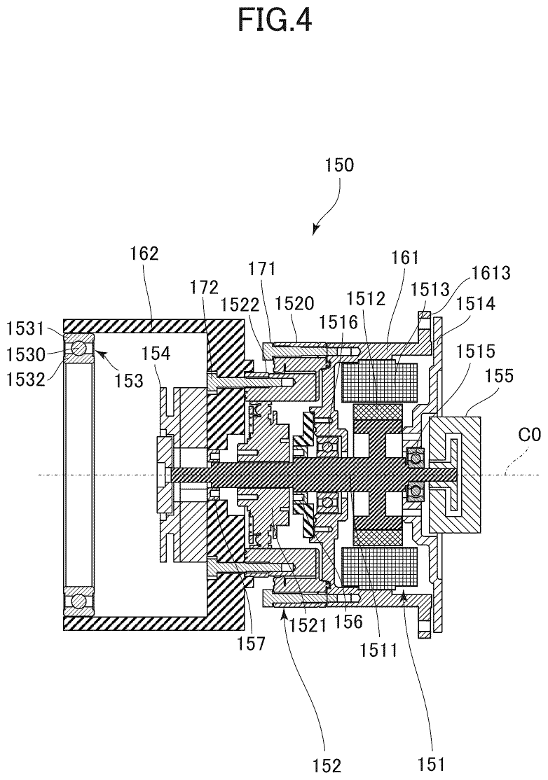

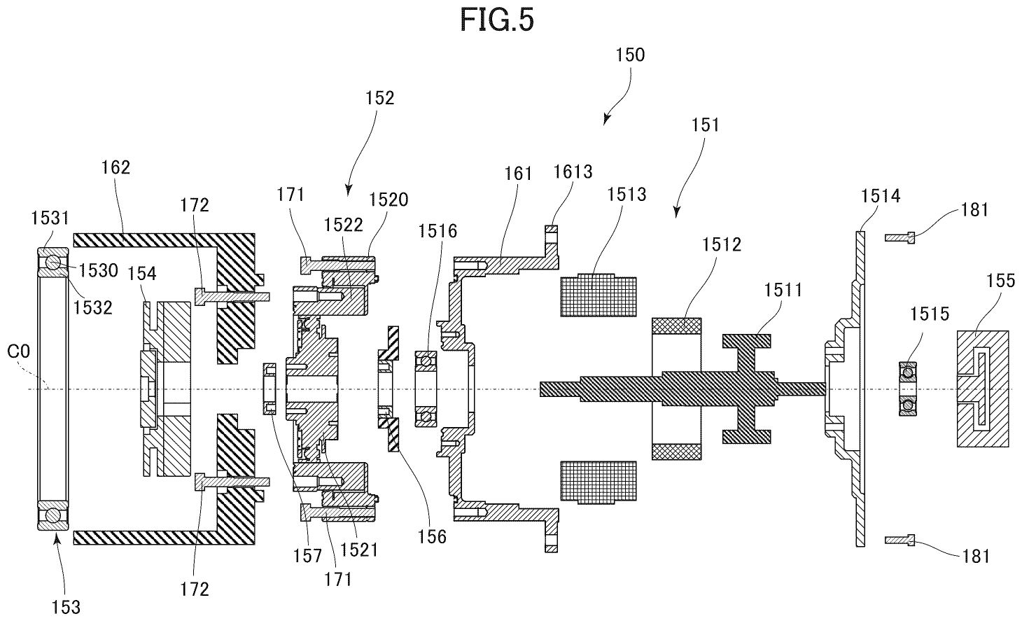

FIG. 4 is a cross-sectional view of the drive unit 150 according to the first embodiment. FIG. 5 is an exploded cross-sectional view of the drive unit 150 according to the first embodiment.

The drive unit 150 of the first embodiment further includes a positioning member 161 that is an example of a first member and a positioning member 162 that is an example of a second member. The positioning member 161 is disposed on the input side of the speed reducer 152, and the positioning member 162 is disposed on the output side of the speed reducer 152. The positioning member 161 includes a flange portion 1613 directly or indirectly connected to the link 111. The link 112 is indirectly connected to the positioning member 162 via the torque sensor 451. That is, the torque sensor 451 is disposed between the positioning member 162 and the link 112.

The motor 151 and the speed reducer 152 are axially aligned by the positioning member 161, and the speed reducer 152 and the bearing 153 are axially aligned by the positioning member 162. That is, the axis of the motor 151, the axis of the speed reducer 152, and the axis of the bearing 153 are aligned with the axis C0 by the positioning members 161 and 162. Therefore, the axis C0 is also the axis of the speed reducer 152, that is, the axis of the drive unit 150. The axis C0 becomes a rotation axis of the joint J2 by assembling the drive unit 150 to the joint J2.

In the first embodiment, the drive unit 150 further includes a brake 154, the encoder 155, and oil seals 156 and 157. In the first embodiment, the plurality of members 151 to 157 are members that need to be axially aligned with each other. The members 151 to 157 are integrally assembled so as to be axially aligned with each other. By axially aligning the members 151 to 157, performance and durability of each of the members 151 to 157 can be improved. In addition, frictional resistance caused by axial misalignment of the members 151 to 157 can be reduced, and positioning control of the robot 10 can be performed with high accuracy. That is, it is possible to cause the robot 10 to perform highly accurate operation with high reproducibility. The drive unit 150 may include members that need to be axially aligned with each other in addition to the members 151 to 157.

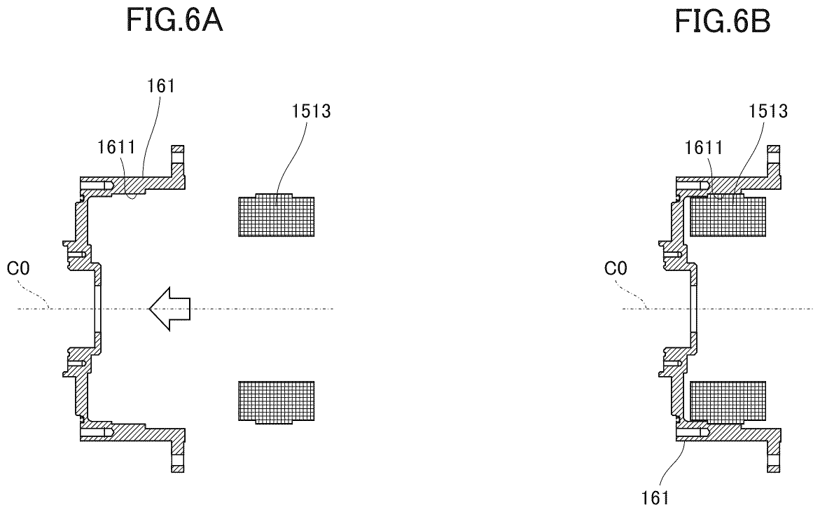

Hereinafter, a method of assembling the drive unit 150 will be described in detail. FIGS. 6A to 16B are explanatory views of the method of assembling the drive unit 150 according to the first embodiment.

First, as illustrated in FIGS. 6A and 6B, a stator 1513 is fitted to a reference surface 1611 of the positioning member 161, and the stator 1513 is attached to the positioning member 161. The reference surface 1611 is a surface based on the axis C0. The reference surface 1611 has a cylindrical shape and can be easily formed by a general-purpose processing machine (not illustrated). FIG. 6A illustrates a state before the stator 1513 is attached to the positioning member 161, and FIG. 6B illustrates a state after the stator 1513 is attached to the positioning member 161.

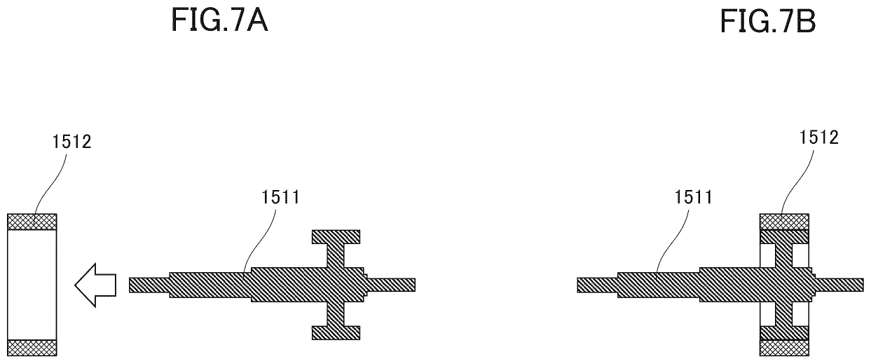

As illustrated in FIGS. 7A and 7B, a motor shaft 1511 is attached to a rotor 1512. FIG. 7A illustrates a state before the motor shaft 1511 is attached to the rotor 1512, and FIG. 7B illustrates a state after the motor shaft 1511 is attached to the rotor 1512.

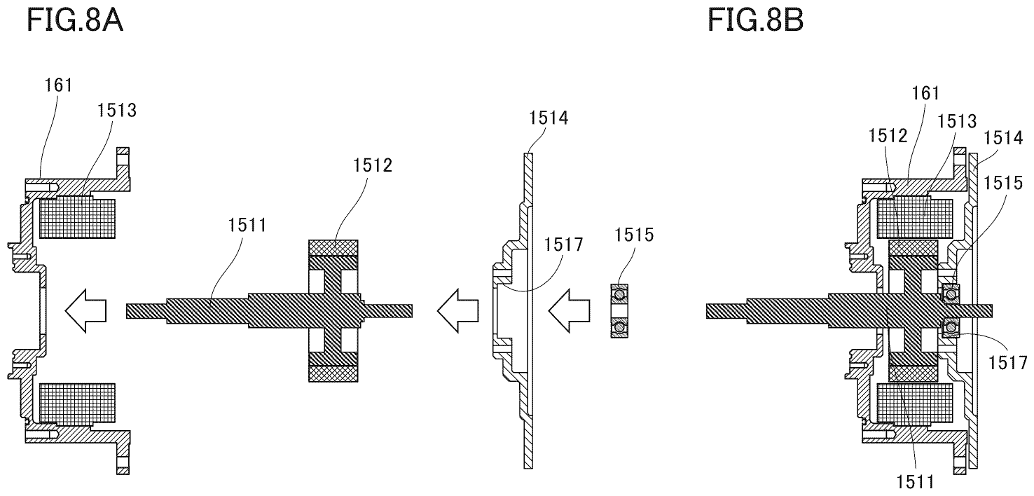

As illustrated in FIGS. 8A and 8B, an encoder stay 1514 has a reference surface 1517 on which a motor bearing 1515 is positioned. The reference surface 1517 is a cylindrical surface, and can be easily formed by a general-purpose processing machine (not illustrated). The motor bearing 1515 is fitted to the reference surface 1517 of the encoder stay 1514. Then, the encoder stay 1514 and the motor bearing 1515 are attached to the motor shaft 1511, and the motor shaft 1511 is inserted into the positioning member 161 such that the rotor 1512 is disposed inside the stator 1513. FIG. 8A illustrates a state before the positioning member 161 and the members 1511 to 1515 of the motor are assembled, and FIG. 8B illustrates a state after the positioning member 161 and the members 1511 to 1515 of the motor are assembled.

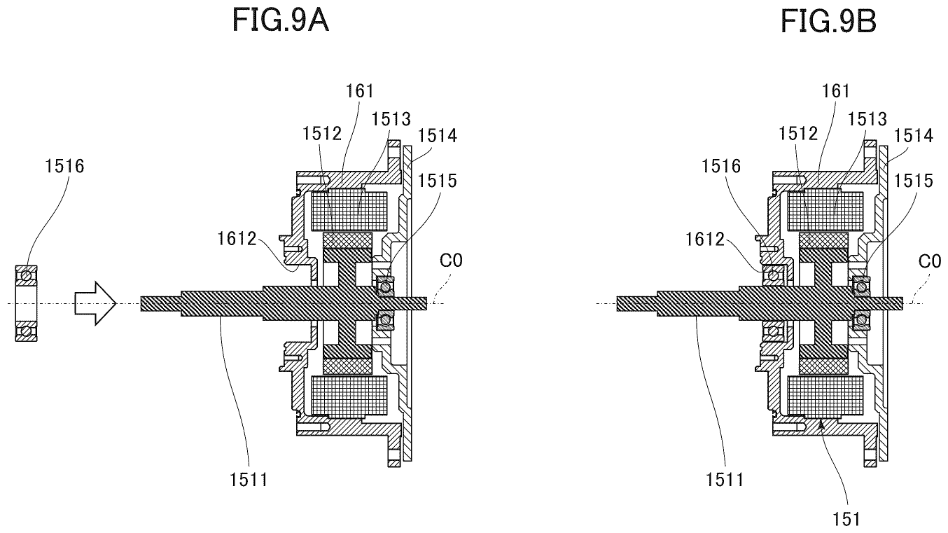

Next, as illustrated in FIGS. 9A and 9B, a motor bearing 1516 is attached to a reference surface 1612 of the positioning member 161. The reference surface 1612 is a surface based on the axis C0. The reference surface 1612 is a cylindrical surface, and can be easily formed by a general-purpose processing machine (not illustrated). As a result, the motor bearing 1516 is positioned by the positioning member 161. When the motor shaft 1511 is inserted into the motor bearing 1516, the motor shaft 1511 is positioned by the positioning member 161 via the motor bearing 1516, whereby the encoder stay 1514 is positioned by the positioning member 161 via the motor shaft 1511 and the motor bearing 1515. That is, the members 1511 to 1516 of the motor 151 are positioned by the positioning member 161 such that the axes of the members 1511 to 1516 of the motor 151 are aligned with the axis C0.

In the first embodiment, the members 1511 to 1516 form the motor 151. FIG. 9A illustrates a state before the positioning member 161 and the members 1511 to 1516 of the motor are assembled, and FIG. 9B illustrates a state after the positioning member 161 and the members 1511 to 1516 of the motor are assembled. The positioning member 161 is formed in a cup shape, the rotor 1512 and the stator 1513 are disposed inside the positioning member 161, and the motor shaft 1511 is disposed across the inside and the outside of the positioning member 161. In this manner, the positioning member 161 also functions as a housing that houses the rotor 1512 and the stator 1513 of the motor 151.

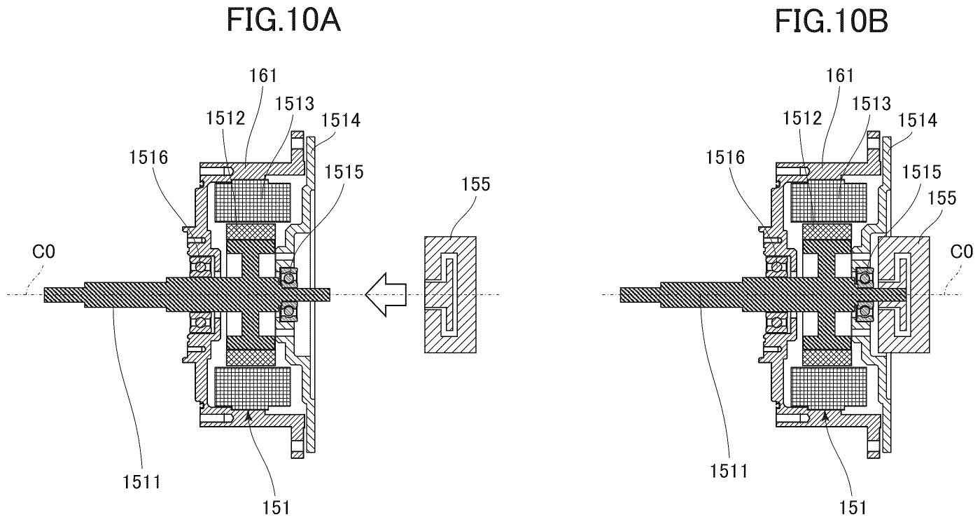

Next, as illustrated in FIGS. 10A and 10B, the encoder 155 is attached to the encoder stay 1514 and the motor shaft 1511. The encoder 155 is attached to the motor shaft 1511 to be positioned by the positioning member 161 via the motor shaft 1511. That is, the encoder 155 is positioned by the positioning member 161 such that the axis of the encoder 155 is aligned with the axis C0. FIG. 10A illustrates a state before the encoder 155 is attached to the encoder stay 1514, and FIG. 10B illustrates a state after the encoder 155 is attached to the encoder stay 1514.

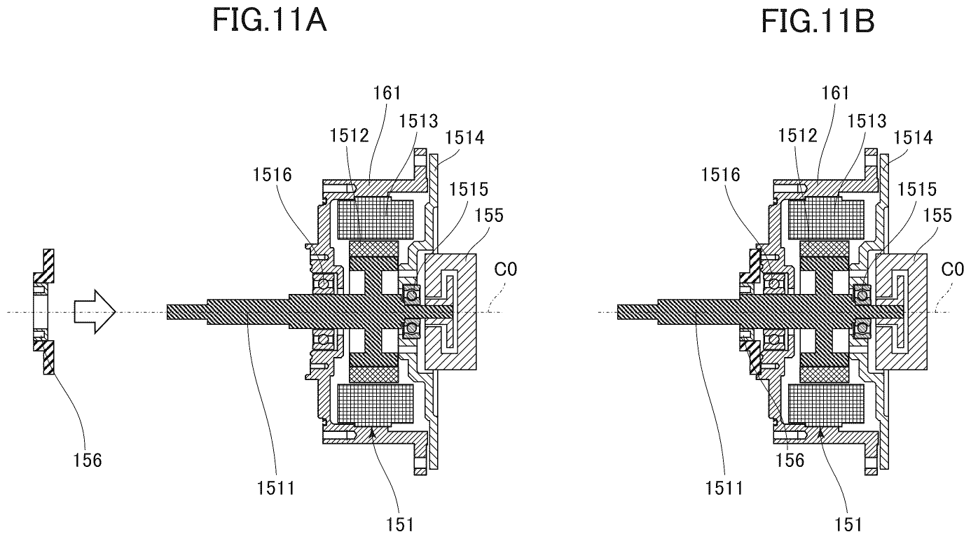

Next, as illustrated in FIGS. 11A and 11B, the oil seal 156 is attached to the positioning member 161. Therefore, the oil seal 156 is supported by the positioning member 161. The oil seal 156 is an example of a first oil seal. The oil seal 156 is provided such that a lip of the oil seal 156 is in contact with the motor shaft 1511. As a result, the oil seal 156 is positioned by the positioning member 161 via the motor bearing 1516 and the motor shaft 1511. The oil seal 156 positioned on the input side of the speed reducer 152 can reduce leakage of oil of the speed reducer 152 described below from the input side of the speed reducer 152 to the rotor 1512 and the stator 1513 via the motor shaft 1511. The positioning member 161 may be provided with a fitting portion, and the oil seal 156 may be directly positioned by the positioning member 161 by being fitted to the fitting portion. FIG. 11A illustrates a state before the oil seal 156 is attached to the positioning member 161, and FIG. 11B illustrates a state after the oil seal 156 is attached to the positioning member 161.

As described above, the members 151, 155, and 156 on the input side of the speed reducer 152 are supported by the positioning member 161 in a state of being positioned by the positioning member 161.

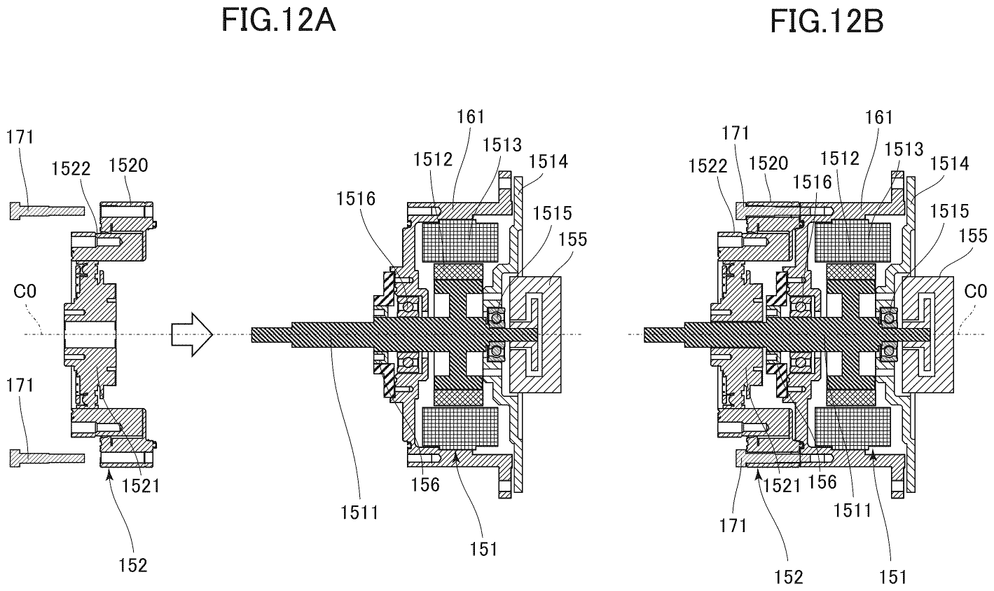

Next, as illustrated in FIGS. 12A and 12B, the speed reducer 152 is attached to the positioning member 161. The speed reducer 152 includes an input unit 1521, an output unit 1522, and a fixing portion 1520. The input unit 1521 and the output unit 1522 rotate with respect to the fixing portion 1520. In addition, the output unit 1522 is decelerated at a predetermined deceleration ratio with respect to the input unit 1521 and rotates. FIG. 12A illustrates a state before the speed reducer 152 is attached to the positioning member 161, and FIG. 12B illustrates a state after the speed reducer 152 is attached to the positioning member 161.

In the first embodiment, the fixing portion 1520 of the speed reducer 152 is fixed to the positioning member 161 by a fastening member 171. When the input unit 1521 of the speed reducer 152 is fitted to the motor shaft 1511, the speed reducer 152 is positioned by the positioning member 161 via the motor shaft 1511. That is, the speed reducer 152 is positioned by the positioning member 161 such that the axis of the speed reducer 152 is aligned with the axis C0.

As described above, the motor 151 and the speed reducer 152 are fixed to the positioning member 161 in a state where the motor 151 and the speed reducer 152 are positioned by the positioning member 161 such that the axes of the motor 151 and the speed reducer 152 are aligned with the axis C0.

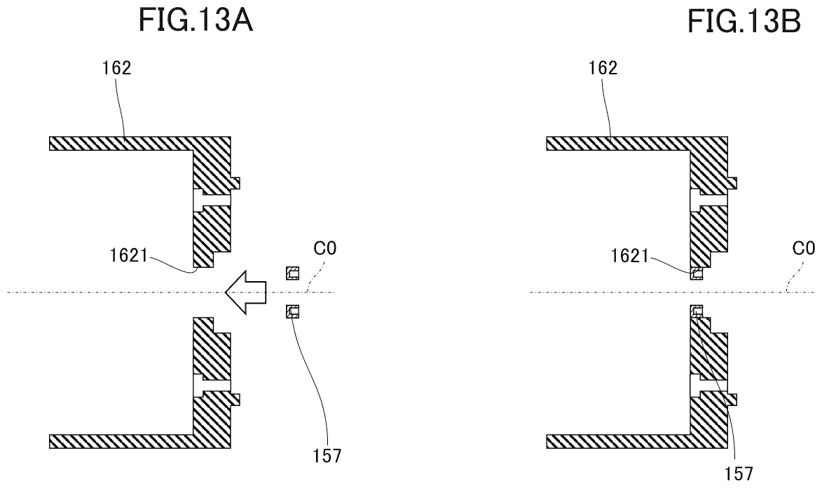

Next, as illustrated in FIGS. 13A and 13B, the oil seal 157 is attached to a reference surface 1621 of the positioning member 162. The reference surface 1621 has a cylindrical shape and can be easily formed by a general-purpose processing machine (not illustrated). Therefore, the oil seal 157 is supported by the positioning member 162. The oil seal 157 is an example of a second oil seal. FIG. 13A illustrates a state before the oil seal 157 is attached to the positioning member 162, and FIG. 13B illustrates a state after the oil seal 157 is attached to the positioning member 162.

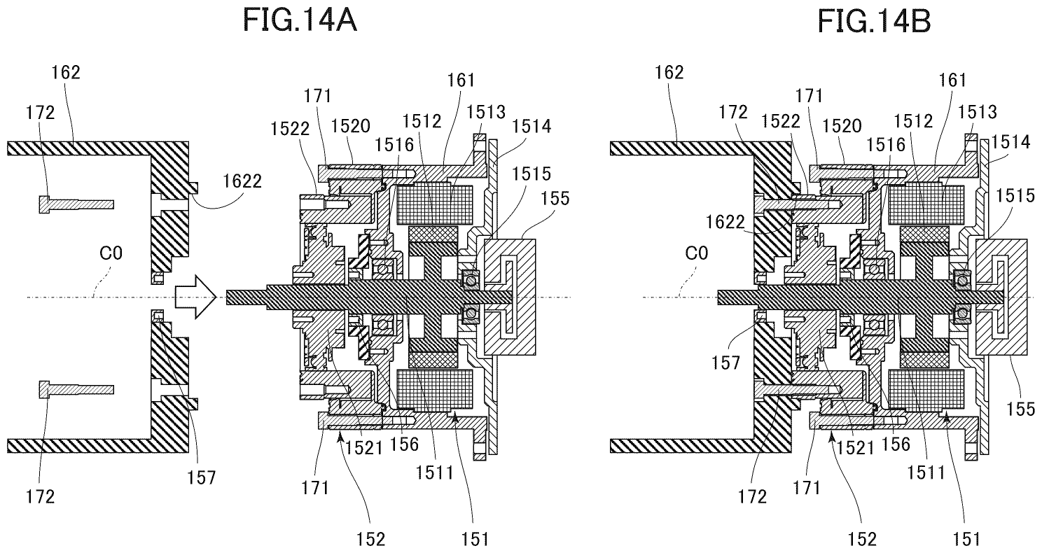

Next, as illustrated in FIGS. 14A and 14B, the positioning member 162 is attached to the speed reducer 152. FIG. 14A illustrates a state before the positioning member 162 is attached to the speed reducer 152, and FIG. 14B illustrates a state after the positioning member 162 is attached to the speed reducer 152.

In the first embodiment, the positioning member 162 is fixed to the output unit 1522 of the speed reducer 152 by fastening members 172. The positioning member 162 has a reference surface 1622, and the positioning member 162 and the speed reducer 152 are positioned by fitting the reference surface 1622 to the output unit 1522 of the speed reducer 152. That is, the positioning member 162 is fixed to the output unit 1522 of the speed reducer 152 such that the axis of the positioning member 162 is aligned with the axis C0. The reference surface 1622 is a cylindrical surface, and can be easily formed by a general-purpose processing machine (not illustrated).

The oil seal 157 is provided such that a lip of the oil seal 157 is in contact with the motor shaft 1511. The oil seal 157 is positioned by the positioning member 161 via the motor shaft 1511. The oil seal 157 positioned on the output side of the speed reducer 152 can reduce leakage of the oil of the speed reducer 152 from the output side of the speed reducer 152 to the brake 154 described below via the motor shaft 1511.

As described above, since the axes of the oil seals 156 and 157 are aligned with the axis C0, the oil seal 156 provided on the input side of the speed reducer 152 and the oil seal 157 provided on the output side of the speed reducer 152 can effectively reduce leakage of the oil (grease) from the speed reducer 152 to the outside. Further, since a pressure of the lip of each of the oil seals 156 and 157 is uniform, it is possible to reduce friction between the oil seals 156 and 157 and the motor shaft 1511 from fluctuating. In addition, since it is possible to reduce leakage of the oil (grease) by the oil seals 156 and 157 and to reduce fluctuation of the friction between the oil seals 156 and 157 and the motor shaft 1511, it is possible to prevent deterioration of detection accuracy of the encoder 155 and the torque sensor 145.

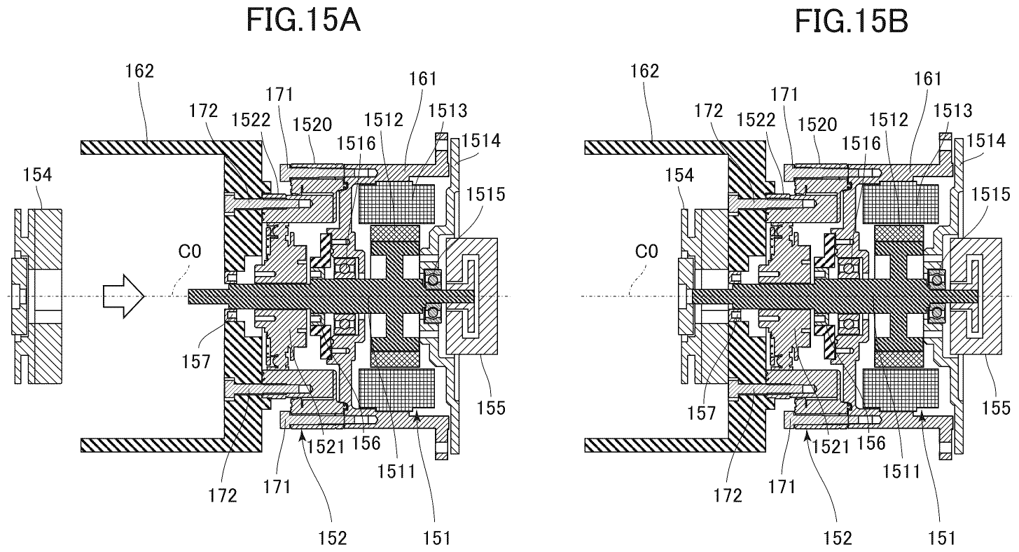

Next, as illustrated in FIGS. 15A and 15B, the brake 154 is attached to the motor shaft 1511 and the positioning member 162. As a result, the brake 154 is positioned by the positioning member 162. FIG. 15A illustrates a state before the brake 154 is attached to the motor shaft 1511, and FIG. 15B illustrates a state after the brake 154 is attached to the motor shaft 1511.

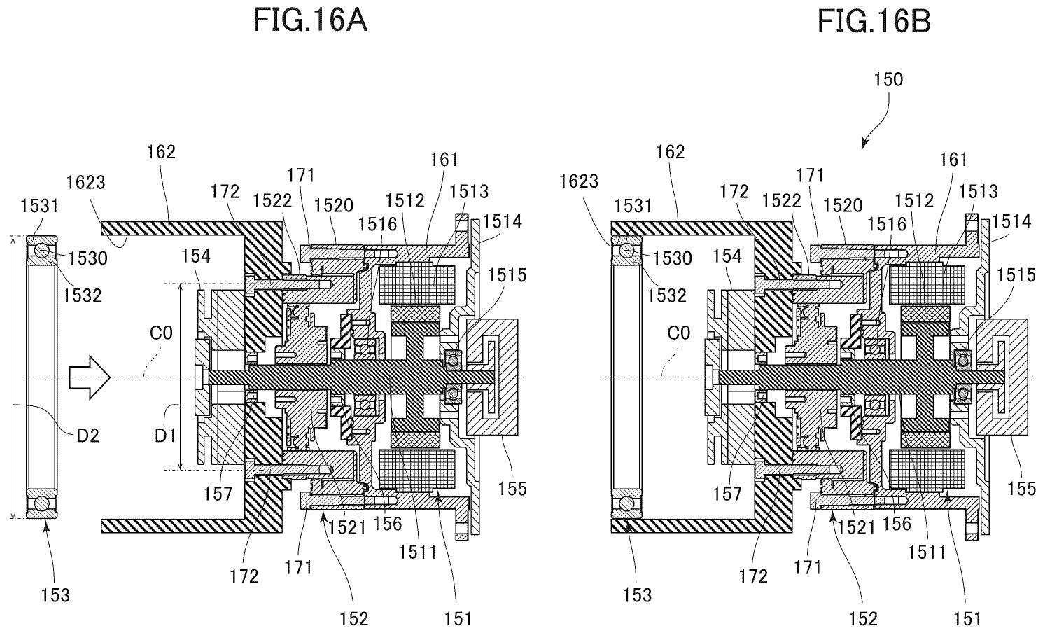

Next, as illustrated in FIGS. 16A and 16B, the bearing 153 is attached to the positioning member 162. FIG. 16A illustrates a state before the bearing 153 is attached to the positioning member 162, and FIG. 16B illustrates a state after the bearing 153 is attached to the positioning member 162.

The positioning member 162 has a reference surface 1623. The reference surface 1623 is a surface based on the axis C0. The reference surface 1623 is a cylindrical surface, and can be easily formed by a general-purpose processing machine (not illustrated). The bearing 153 is positioned by the positioning member 162 by being fitted to the reference surface 1623 of the positioning member 162. That is, the bearing 153 is positioned by the positioning member 162 such that the axis of the bearing is aligned with the axis C0.

In the first embodiment, the outer ring 1531 of the bearing 153 is attached to the reference surface 1623 of the positioning member 162. That is, the outer ring 1531 of the bearing 153 is supported by the positioning member 162.

As described above, the bearing 153, the brake 154, and the oil seal 157 provided on the output side of the speed reducer 152 are supported by the positioning member 162 in a state of being positioned by the positioning member 162. That is, the speed reducer 152, the bearing 153, the brake 154, and the oil seal 157 are fixed to the positioning member 162 in a state where the speed reducer 152, the bearing 153, the brake 154, and the oil seal 157 are positioned by the positioning member 162 such that the axes of the speed reducer 152, the bearing 153, the brake 154, and the oil seal 157 are aligned with the axis C0.

The positioning member 162 is fixed to the output unit 1522 of the speed reducer 152 by the plurality of fastening members 172 arranged in a circumferential direction around the axis C0. An outer diameter D2 of the bearing 153 is preferably larger than a diameter D1 of an imaginary circle passing through the centers of the plurality of fastening members 172. This facilitates assembling work for the positioning member 162 and the speed reducer 152.

FIG. 16B illustrates the drive unit 150 assembled as described above. Since the axes of the members 151 to 157 included in the drive unit 150 are aligned with the axis C0 by the positioning members 161 and 162, it is not necessary to perform axial alignment work when the drive unit 150 is assembled to the link 111.

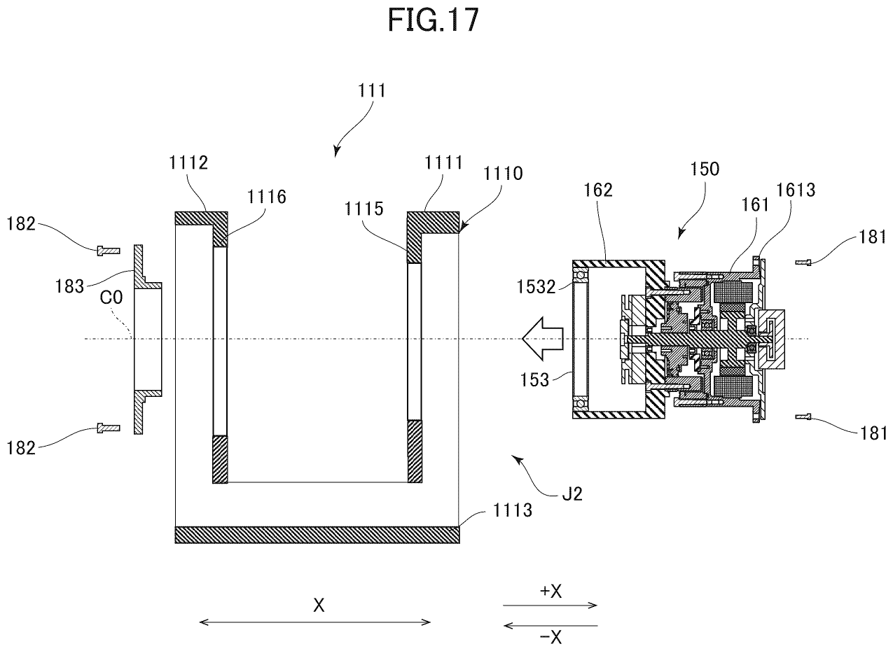

Next, a method of assembling the joint J2 of the robot 10 will be described. FIG. 17 is an explanatory view of the method of assembling the joint J2 of the robot 10 according to the first embodiment.

The U-shaped portion 1110 includes a base portion 1113 and a pair of support portions 1111 and 1112 disposed on the base portion 1113 while being spaced apart from each other in an X direction. The support portions 1111 and 1112 are two portions that form a part of the U-shaped portion 1110. The X direction is an example of a predetermined direction, and is a direction along the axis C0. In the X direction, one direction is defined as a +X direction, and a direction opposite to the +X direction is defined as a −X direction. The +X direction is a direction from the support portion 1112 toward the support portion 1111. The −X direction is a direction from the support portion 1111 toward the support portion 1112. The support portion 1111 includes an annular portion 1115 in which the drive unit 150 is disposed. The support portion 1112 includes an annular portion 1116 in which the drive unit 150 is disposed.

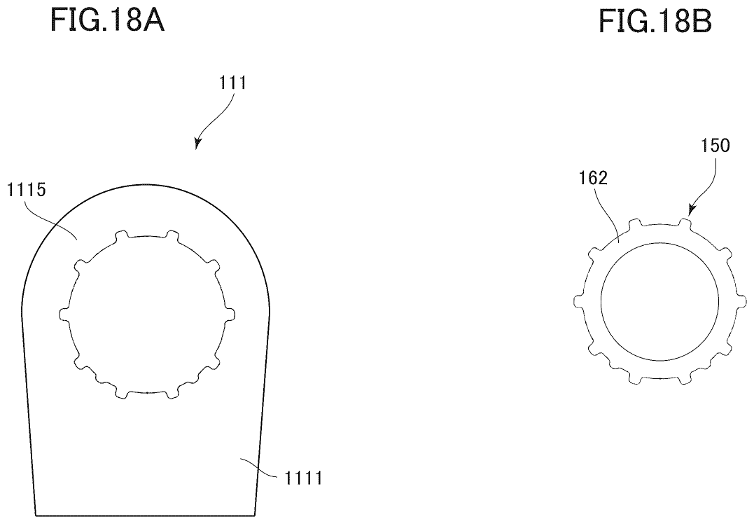

FIG. 18A is a side view of the link 111 when the link 111 according to the first embodiment is viewed in the −X direction. FIG. 18B is a side view of the drive unit 150 when the drive unit 150 according to the first embodiment is viewed in the +X direction. The annular portion 1115 illustrated in FIG. 18A has an opening through which the drive unit 150 illustrated in FIG. 18B can pass.

As illustrated in FIG. 17, the drive unit 150 is moved in the −X direction to pass through the opening of the annular portion 1115 of the support portion 1111, and the drive unit 150 is disposed between the pair of support portions 1111 and 1112. Then, the flange portion 1613 of the positioning member 161 is fixed to the annular portion 1115 of the support portion 1111 by a fastening member 181. Further, a coupling member 183 is fitted to the inner ring 1532 of the bearing 153 of the drive unit 150, and the coupling member 183 is fixed to the annular portion 1116 of the support portion 1112 by a fastening member 182. At this time, the coupling member 183 and the inner ring 1532 of the bearing 153 are preferably fitted by transition fitting or interference fitting.

The coupling member 183 has a connection surface connected to the link 111 and a reference surface connected to the inner ring 1532 of the bearing 153. The reference surface is a cylindrical surface, and the connection surface is an annular surface. The coupling member 183 can be formed by a general-purpose processing machine.

Then, the link 112 is fixed to the positioning member 162 via the torque sensor 451, whereby the assembly of the joint J2 is completed.

As described above, the positioning member 161 is supported by the support portion 1111 of the link 111 by fixing the flange portion 1613 of the positioning member 161 to the link 111, and the inner ring 1532 of the bearing 153 is supported by the support portion 1112 of the link 111 by fixing the inner ring 1532 of the bearing 153 to the link 111 via the coupling member 183. As a result, the drive unit 150 is supported by the pair of support portions 1111 and 1112 as illustrated in FIG. 3.

The reference surfaces of the positioning member 161, the positioning member 162, the encoder stay 1514, and the coupling member 183 can be formed by a general-purpose processing machine (not illustrated) as described above. Examples of the general-purpose processing machine include two types of processing machines: a milling machine and a lathe.

The milling machine flattens the surface by moving an end mill in parallel while rotating the end mill, and can perform flat machining with high accuracy. In addition, the milling machine can process a plurality of surfaces having steps with high precision parallelism by stably pressing a workpiece.

Since the lathe cuts a workpiece while rotating the workpiece, it is possible to perform machining with high dimensional accuracy using a rotation axis as a datum axis. Therefore, the lathe can process a plurality of surfaces perpendicular to the rotation axis with high precision parallelism, and can process a plurality of cylindrical surfaces on the rotation axis with high coaxiality. Further, it is possible to achieve high perpendicularity between the plurality of surfaces perpendicular to the rotation axis, and cylindrical surfaces along the rotation axis with high dimensional accuracy.

As described above, the reference surfaces of the positioning member 161, the positioning member 162, and the coupling member 183 can be processed with high accuracy by a general-purpose processing machine. Therefore, the oil seal 156, the motor 151, and the encoder 155 can be assembled to the fixing portion 1520 of the speed reducer 152 with high assembly accuracy via the positioning member 161. The oil seal 157, the brake 154, and the bearing 153 can be assembled to the output unit 1522 of the speed reducer 152 with high assembly accuracy via the positioning member 162. Furthermore, the coupling member 183 can be assembled following the bearing 153.

That is, the motor 151, the encoder 155, the brake 154, the bearing 153, and the oil seals 156 and 157 can be assembled with high assembly accuracy such that the axes thereof are aligned with the axis C0 that is the rotation axis of the speed reducer 152. Therefore, the drive unit 150 can be assembled with high accuracy, and the drive unit 150 can be caused to function as a rotary joint with compensated accuracy.

Meanwhile, the pair of support portions 1111 and 1112 of the link 111 do not need to have a highly accurate positional relationship with each other unlike the link 111X of the comparative example. That is, parallelism of the pair of support portions 1111 and 1112 and coaxiality and size tolerance (fitting tolerance) of the annular portions 1115 and 1116 in which the drive unit 150 is disposed do not need to be as highly accurate as the drive unit 150.

Since the accuracy of the joint J2 is compensated by the drive unit 150, the drive unit 150 can be installed in the U-shaped portion 1110 of the link 111 to function as the joint J2 of the robot 10. A relative position error between the two support portions 1111 and 1112 is absorbed by an allowable inclination, an internal gap, or a fitting gap of the bearing 153 itself.

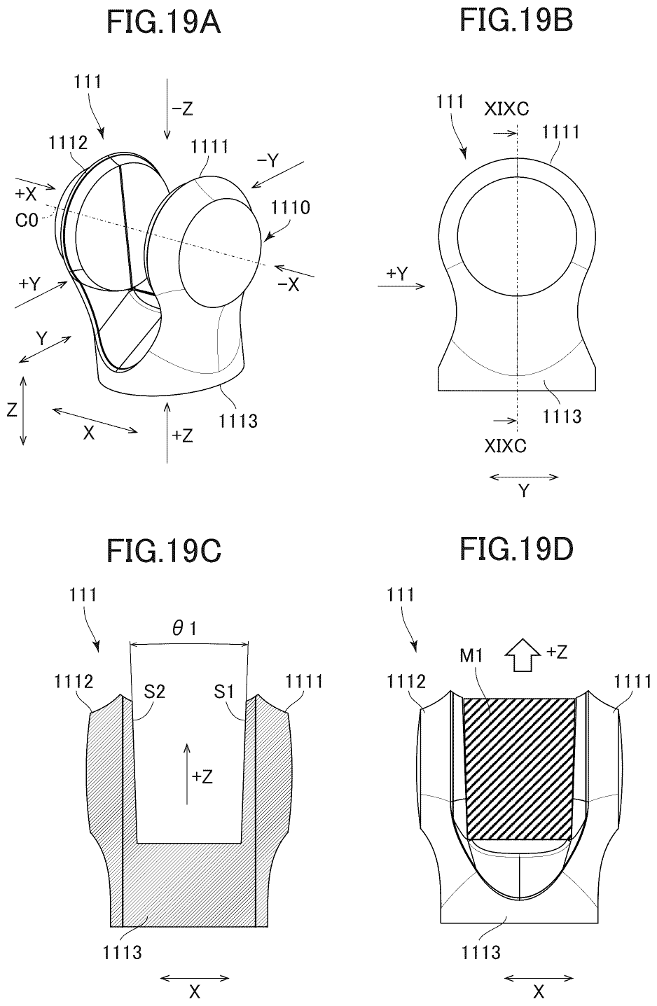

Next, a method of manufacturing the link 111 according to the first embodiment will be described. FIG. 19A is a perspective view of the link 111 according to the first embodiment. As described above, the link 111 has the U-shaped portion 1110. The U-shaped portion 1110 includes the base portion 1113 and the two support portions 1111 and 1112.

Here, the X direction, a Y direction, and a Z direction orthogonal to each other are defined. The X direction is a direction along the axis C0 as described above, and the pair of support portions 1111 and 1112 are spaced apart from each other in the X direction. The X direction is also a thickness direction of the support portions 1111 and 1112. The Z direction is a longitudinal direction of the support portions 1111 and 1112, and the Y direction is a lateral direction of the support portions 1111 and 1112. The Z direction is also a height direction of each of the support portions 1111 and 1112. The Y direction is also a direction parallel to the base portion 1113 and a width direction of each of the support portions 1111 and 1112. A first end of the support portion 1111 in the Z direction is a fixed end connected to the base portion 1113, and a second end of the support portion 1111 in the Z direction is an open end. A first end of the support portion 1112 in the Z direction is a fixed end connected to the base portion 1113, and a second end of the support portion 1112 in the Z direction is an open end. A direction in which the U-shaped portion 1110 is opened is the +Z direction.

In the Z direction, a direction from the open ends of the support portions 1111 and 1112 toward the base portion 1113 is defined as a −Z direction, and a direction from the base portion 1113 toward the open ends of the support portions 1111 and 1112 opposite to the −Z direction is defined as a +Z direction. In the Y direction, one direction is defined as a +Y direction, and a direction opposite to the +Y direction is defined as a −Y direction. As described above, one direction of the X direction is defined as the +X direction, and a direction opposite to the +X direction is defined as the −X direction. FIG. 19B is a side view of the link 111 when the link 111 according to the first embodiment is viewed in the −X direction.

In the first embodiment, the link 111 is manufactured by integral molding using a mold. A material of the link 111 may be a resin or metal. FIG. 19C is a cross-sectional view of the link 111 according to the first embodiment. FIG. 19C is a cross-sectional view of the link 111 taken along line XIXC-XIXC in FIG. 19B. FIG. 19D is an explanatory view of the method of manufacturing the link 111 according to the first embodiment. FIG. 19D is a front view of the link 111 when the link 111 is viewed in the +Y direction.

A mold (not illustrated) is tightened to inject a molten material into a cavity in the mold, the mold is cooled, and then the mold is opened to remove the link 111 from the mold.

Each of the support portions 1111 and 1112 has a draft angle such that a part M1 of the mold positioned between the support portions 1111 and 1112 is removed in the +Z direction in a mold opening process. The support portion 1111 has a tapered surface S1 forming the draft angle, and the support portion 1112 has a tapered surface S2 forming the draft angle. The tapered surfaces S1 and S2 face each other in the X direction. The tapered surfaces S1 and S2 are inclined so as to be away from each other in the X direction toward the +Z direction. That is, the tapered surfaces S1 and S2 are inclined such that a distance between the tapered surfaces S1 and S2 increases as the distance from the base portion 1113 increases. An opening angle θ1 of the tapered surfaces S1 and S2 is set to a predetermined angle such that the part M1 of the mold is removed from between the support portions 1111 and 1112.

As described above, according to the first embodiment, the support portions 1111 and 1112 of the link 111 do not need to have a highly accurate positional relationship with each other. That is, it is not necessary to provide a highly accurate positioning reference for the support portions 1111 and 1112.

A force received by the support portions 1111 and 1112 from the drive unit 150 is transmitted to the base portion 1113 via the support portions 1111 and 1112. By integrally molding the support portions 1111 and 1112 with the base portion 1113, it is possible to form a transmission path for guiding the force straight from the support portions 1111 and 1112 in the −Z direction. Therefore, it is not necessary to make the U-shaped portion 1110 as stiff as the comparative example, and the U-shaped portion 1110 can be made thinner than the comparative example.

When the U-shaped portion 1110 is thinned, the support portions 1111 and 1112 can be thinned in the thickness direction of the support portions 1111 and 1112 and an axial direction of the drive unit 150. In addition, a recess can be provided in the support portions 1111 and 1112 or the base portion 1113.

As described above, it is possible to reduce the size and weight of the link 111 while ensuring moldability of the link 111, assembly accuracy and assemblability of the joint J2, and the stiffness of the link 111, and thus, it is possible to reduce the size and weight of the robot 10 and to reduce the cost related to the manufacturing of the robot 10.

Since the axially aligned drive unit 150 is incorporated in the robot 10, the robot 10 can be caused to perform highly accurate assembly work, and accuracy of an operation performed by the robot 10 can be improved. Furthermore, since durability of the robot 10 is improved, the cost required for maintenance can also be reduced.

Furthermore, according to the first embodiment, it is possible to cause the robot 10 to perform work that requires highly accurate positioning reproducibility and high-speed operation, such as assembly work with a minute load of several grams. Therefore, the robot 10 can be caused to perform high-mix low-volume production, a startup period of a production line in this case can be shortened, so that a startup cost of the production line can be reduced.

### First Modified Example

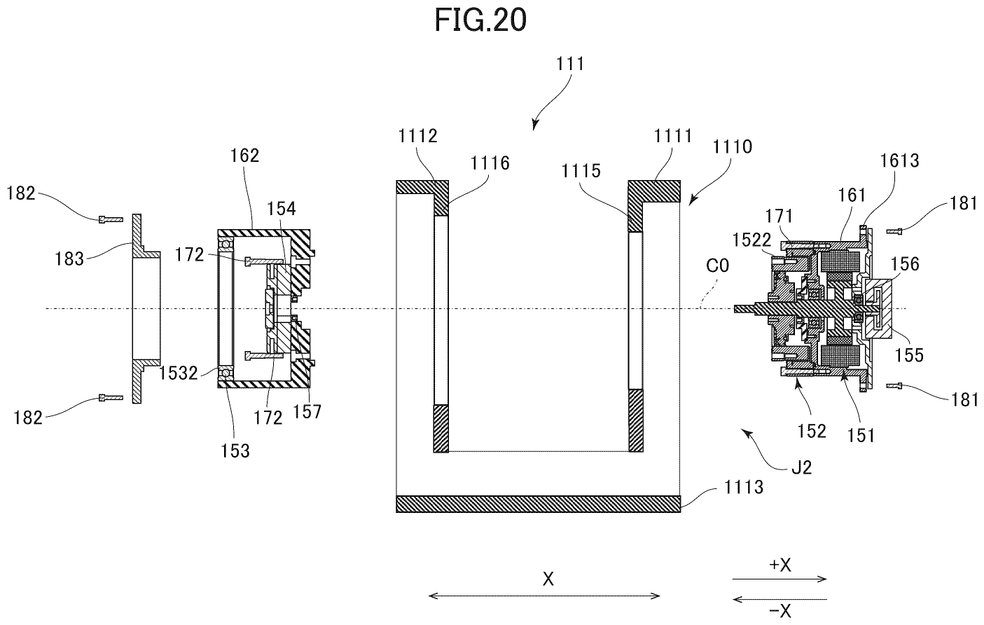

The drive unit 150 may also be unitized in the middle of being assembled to the joint J2. FIG. 20 is an explanatory view of a method of assembling a joint J2 according to a first modified example.

As illustrated in FIG. 20, a positioning member 161, a motor 151, a speed reducer 152, an encoder 155, and an oil seal 156 are unitized to form a first unit, and a positioning member 162, a bearing 153, a brake 154, and an oil seal 157 are unitized to form a second unit.

Then, the first unit is moved in the −X direction to pass through an opening of an annular portion 1115 of a support portion 1111, and the first unit is disposed between the pair of support portions 1111 and 1112. Then, a flange portion 1613 of a positioning member 161 is fixed to the annular portion 1115 of the support portion 1111 by a fastening member 181. The second unit is disposed between the pair of support portions 1111 and 1112 by moving the second unit in the +X direction to pass through an opening of an annular portion 1116 of the support portion 1112. The second unit is fixed to an output unit 1522 of the speed reducer 152 of the first unit by a fastening member 172. Therefore, the assembly of the drive unit 150 is completed.

Further, a coupling member 183 is fitted to an inner ring 1532 of the bearing 153 of the drive unit 150, and the coupling member 183 is fixed to the annular portion 1116 of the support portion 1112 by a fastening member 182. As a result, the drive unit 150 is assembled to the link 111.

### Second Modified Example

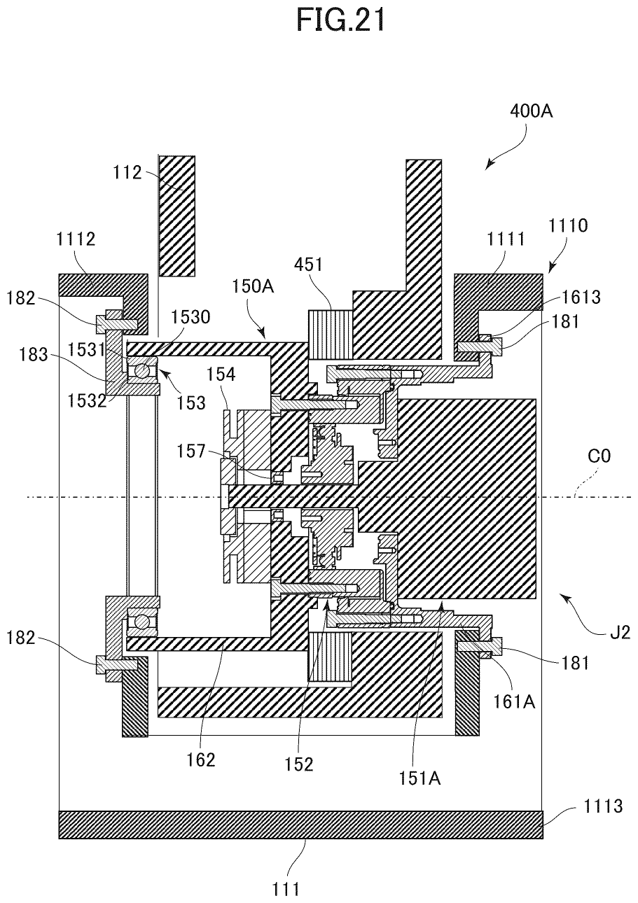

In the first embodiment, a case where the motor 151 is assembled has been described as an example, but the present technology is not limited thereto. FIG. 21 is an explanatory view of a joint structure 400A of a joint J2 according to a second modified example.

The joint structure 400A of the second modified example includes a drive unit 150A and a torque sensor 451. The drive unit 150A includes a motor 151A and a positioning member 161A instead of the motor 151 and the positioning member 161. A configuration of the drive unit 150A other than the motor 151A and the positioning member 161A is similar to that of the drive unit 150 other than the motor 151 and the positioning member 161, and thus a description thereof is omitted.

The motor 151A is a component in which a rotor, a stator, and the like are integrated, and a general-purpose motor can be applied. The positioning member 161A is an example of the first member, and the motor 151A is attached to the positioning member 161A. As described above, the motor 151A may be an integrated component.

### Third Modified Example

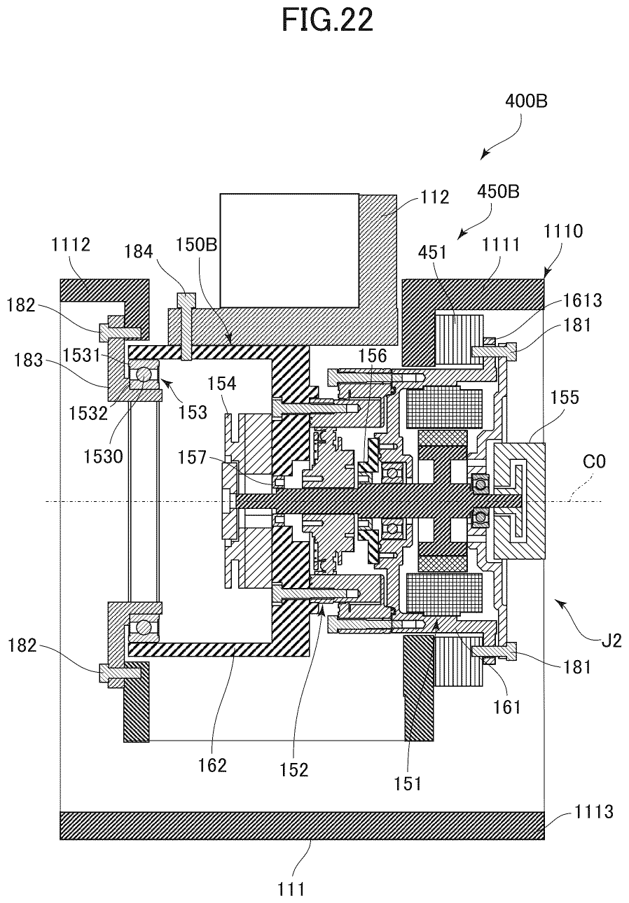

In the first embodiment, as illustrated in FIG. 3, a case where the torque sensor 451 is disposed between the positioning member 162 and the link 112 has been described, but the present technology is not limited thereto. FIG. 22 is an explanatory view of a joint structure 400B of a joint J2 according to a third modified example.

The joint structure 400B of the third modified example includes a drive unit 150 and a torque sensor 451. The torque sensor 451 is disposed between a positioning member 161 of the drive unit 150 and a link 111. As such, the torque sensor 451 may be disposed between the drive unit 150 and the link 111. A link 112 may be directly connected to a positioning member 162 by a fastening member 184.

### Fourth Modified Example

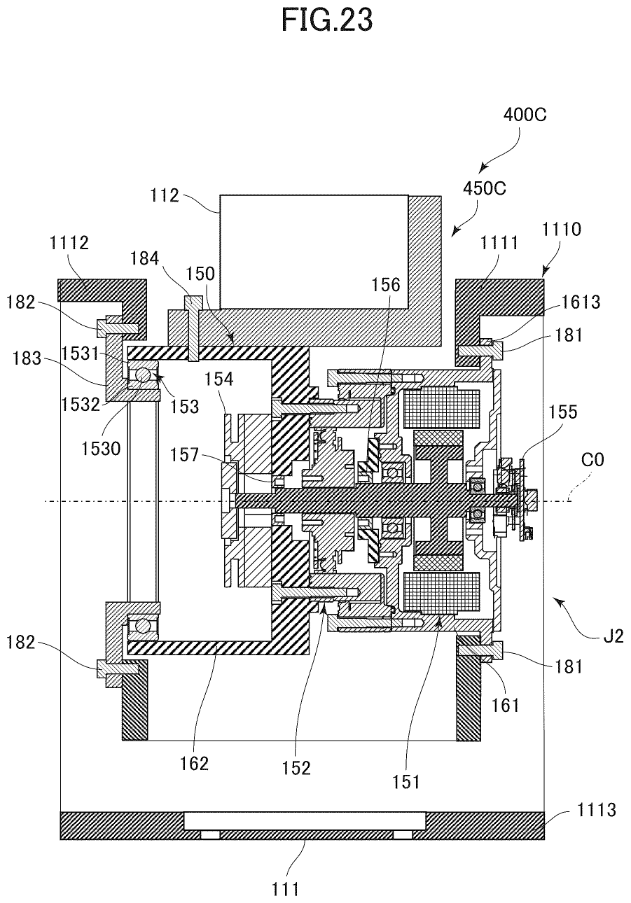

In the first embodiment, as illustrated in FIG. 3, a case where the torque sensor 451 is disposed between the positioning member 162 and the link 112 has been described, but the present technology is not limited thereto. FIG. 23 is an explanatory view of a joint structure 400C of a joint J2 according to a fourth modified example. The joint structure 400C of the fourth modified example includes a drive unit 150. That is, a torque sensor 451 may be omitted in the joint structure 400C. A link 112 may be directly connected to a positioning member 162 by a fastening member 184.

### Fifth Modified Example

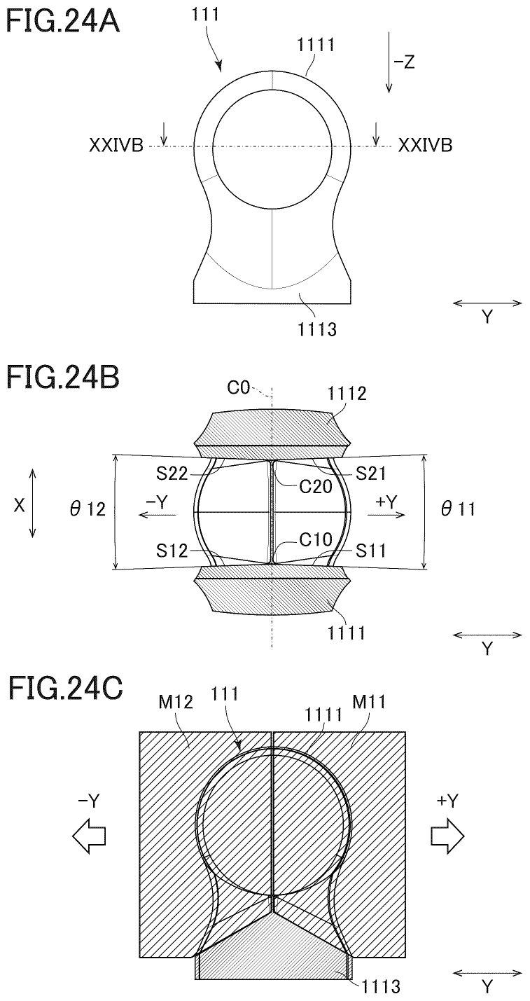

Next, a method of manufacturing a support according to a fifth modified example of the first embodiment will be described. In the fifth modified example, a link 111 that is a support is manufactured by integral molding using a mold. FIG. 24A is a side view of the link 111 when the link 111 according to the fifth modified example is viewed in the −X direction. FIG. 24B is a cross-sectional view of the link 111 according to the fifth modified example. FIG. 24B is a cross-sectional view of the link 111 taken along line XXIVB-XXIVB in FIG. 24A. FIG. 24C is an explanatory view of a method of manufacturing the link 111 according to the fifth modified example. FIG. 24C is a front view of the link 111 when the link 111 is viewed in the +Y direction.

A mold (not illustrated) is tightened to inject a molten material into a cavity in the mold, the mold is cooled, and then the mold is opened to remove the link 111 from the mold.

Each of support portions 1111 and 1112 has a draft angle such that a part M11 of a mold positioned between the support portions 1111 and 1112 is removed in the +Y direction and a part M12 of a mold is removed in the −Y direction in a mold opening process. The support portion 1111 has tapered surfaces S11 and S12 forming draft angles, and the support portion 1112 has tapered surfaces S21 and S22 forming the draft angles. The tapered surfaces S11 and S21 face each other in the X direction. The tapered surfaces S12 and S22 face each other in the X direction.

The tapered surfaces S11 and S21 are inclined so as to be away from each other in the X direction toward the +Y direction. The tapered surfaces S12 and S22 are inclined so as to be away from each other in the X direction toward the −Y direction. That is, the tapered surface S11 is inclined such that a distance to the tapered surface S21 increases as the distance from a center C10 of the support portion 1111 in the Y direction increases in the +Y direction, and the tapered surface S21 is inclined such that a distance to the tapered surface S11 increases as the distance from a center C20 of the support portion 1112 in the Y direction increases in the +Y direction. Further, the tapered surface S12 is inclined such that a distance to the tapered surface S22 increases as the distance from the center C10 of the support portion 1111 in the Y direction increases in the −Y direction, and the tapered surface S22 is inclined such that a distance to the tapered surface S12 increases as the distance from the center C20 of the support portion 1112 in the Y direction increases in the −Y direction. An opening angle θ11 of the tapered surfaces S11 and S21 is set to a predetermined angle such that the part M11 of the mold is removed in the +Y direction from between the support portions 1111 and 1112. An opening angle θ12 of the tapered surfaces S12 and S22 is set to a predetermined angle such that the part M12 of the mold is removed in the −Y direction from between the support portions 1111 and 1112.

### Sixth Modified Example

Next, a method of manufacturing a link 111 according to a sixth modified example of the first embodiment will be described. Although not illustrated, the link 111 can be molded without having a draft angle by using a molding method of decomposing a mold, such as gypsum casting, sand mold casting, or lost wax casting. With the molding methods, it is also possible to form an undercut in the link 111. For example, a width of an inner bottom side of a U-shaped portion 1110 may be equal to or larger than a width of an inner opening side of the U-shaped portion 1110.

### Seventh Modified Example

In the first embodiment, a case where the link 111 that is a support is formed by integral molding has been described, but the present technology is not limited thereto. As long as a transmission path of a force from the support portions 1111 and 1112 to the base portion 1113 is straight as described in the first embodiment, the support portions 1111 and 1112 and the base portion 1113 may be configured as separate members.

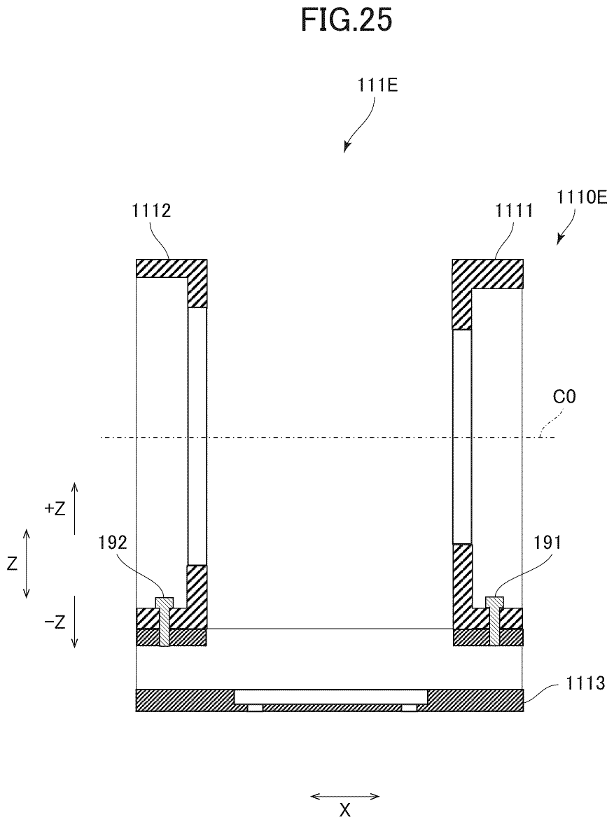

FIG. 25 is a cross-sectional view of a link 111E that is an example of a support according to a seventh modified example. The link 111E has a U-shaped portion 1110E having a U shape. The U-shaped portion 1110E includes a base portion 1113 and a pair of support portions 1111 and 1112, but the base portion 1113 and the pair of support portions 1111 and 1112 are formed as separate members.

The pair of support portions 1111 and 1112 are fastened to the base portion 1113 by fastening members 191 and 192 in a direction intersecting the X direction, that is, in the Z direction orthogonal to the X direction in the seventh modified example to be integrated with the base portion 1113.

A force from a drive unit 150 received by the support portions 1111 and 1112 is transmitted to the base portion 1113 via the support portions 1111 and 1112. By fixing the support portions 1111 and 1112 to the base portion 1113 in the Z direction by the fastening members 191 and 192, it is possible to form a transmission path for guiding the force straight from the support portions 1111 and 1112 in the −Z direction as in the first embodiment.

### Second Embodiment

Next, a second embodiment will be described in detail. The present disclosure is applicable not only to a robot but also to a drive device including a motor, a speed reducer, and a bearing. For example, the present disclosure is applicable to a drive device of an automobile. In the second embodiment, an electric vehicle will be described as an example.

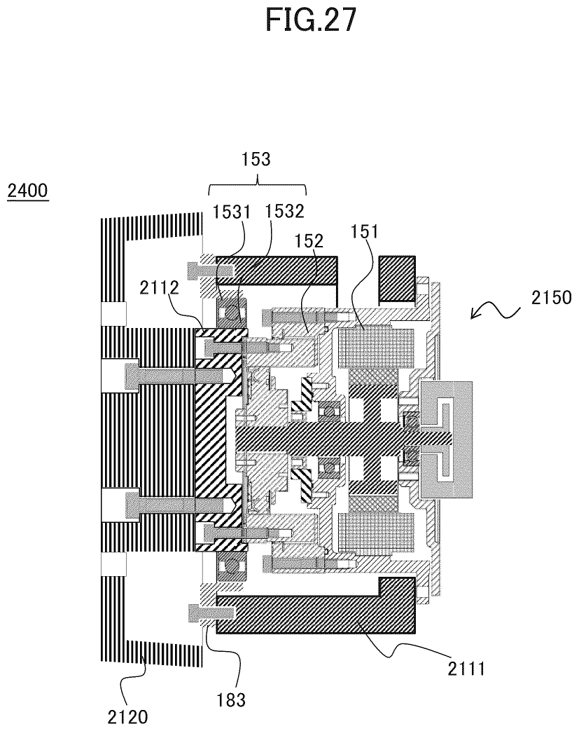

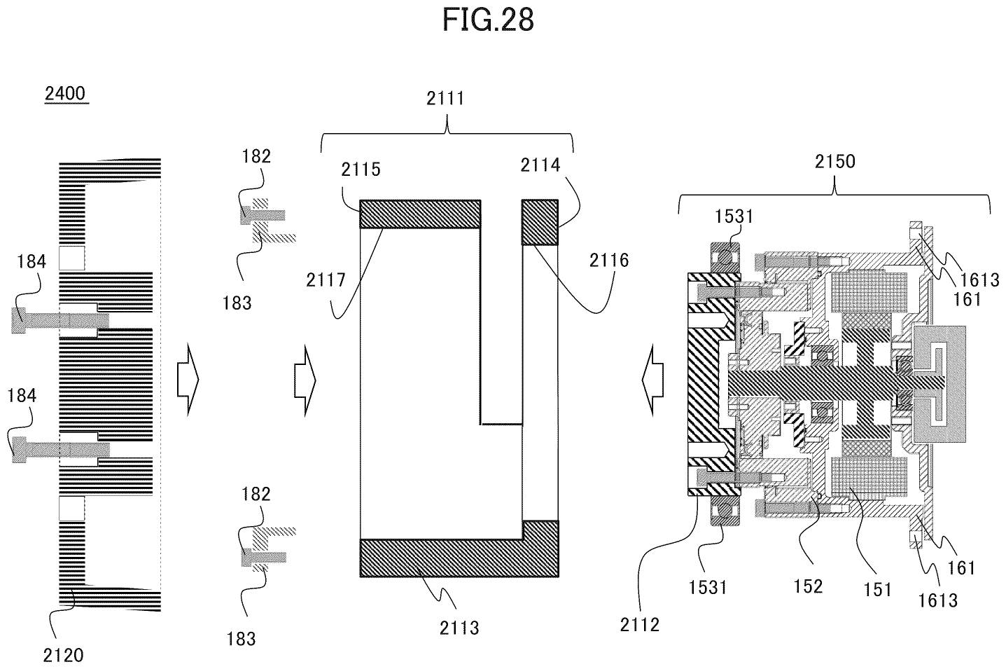

FIG. 27 is an explanatory view of a drive structure 2400 of an automobile according to the second embodiment, the drive structure 2400 including a motor and a wheel. FIG. 28 is an explanatory view of a method of assembling the drive structure 2400 of the automobile according to the second embodiment, the drive structure 2400 including the motor and the wheel. In the following, the same reference numerals will be used for the same or corresponding configurations as those of the first embodiment, and a description thereof is omitted or simplified, and differences from the first embodiment will be mainly described.

Referring to FIG. 27, the drive structure 2400 of the second embodiment includes a housing 2111, a drive unit 2150, and a wheel 2120 of a tire. The housing 2111 is an example of the support. The drive unit 2150 is supported by the housing 2111. The drive unit 2150 includes a motor 151, a speed reducer 152, and a bearing 153. The bearing 153 includes an outer ring 1531 and an inner ring 1532. The motor 151 is provided on an input side of the speed reducer 152, and the bearing 153 is provided on an output side of the speed reducer 152. The motor 151 is a drive source of the wheel 2120, and drives a wheel shaft 2112 via the speed reducer 152.

The bearing 153 is disposed between the housing 2111 and the drive unit 2150. As in the first embodiment described above, the output side of the speed reducer 152 of the drive unit 2150 and the wheel shaft 2112 are connected to the housing 2111 via the bearing 153 and a coupling member 183. The wheel shaft 2112 functions as a positioning member that positions the bearing 153 and the speed reducer 152 with respect to the drive unit 2150. In the second embodiment, the inner ring 1532 of the bearing 153 is disposed to face the drive unit 2150, and the outer ring 1531 of the bearing 153 is disposed to face the housing 2111.

The motor 151, the speed reducer 152, and the bearing 153 become frictional resistance when axes thereof are misaligned from each other. Therefore, in order to perform highly efficient driving, it is required to position the motor 151, the speed reducer 152, and the bearing 153 with high accuracy, that is, to align the axes of the motor 151, the speed reducer 152, and the bearing 153 with each other.

The housing 2111 has an opening portion through which cables pass and has a substantially U-shaped portion (see FIG. 28). The drive unit 2150 is disposed in the U-shaped portion. In the second embodiment, the drive unit 2150 is mounted on the U-shaped portion so as to be integrally detachable from the U-shaped portion of the housing 2111. In other words, the drive unit 2150 is unitized, that is, integrated, and attached to the housing 2111 so as to be detachable from the housing 2111 in an integrated state.

Next, the method of assembling the drive structure 2400 according to the second embodiment will be described with reference to FIG. 28. Similarly to the above-described first embodiment, the housing 2111 that is the support includes a base portion 2113 and a pair of support portions 2114 and 2115 spaced apart from the base portion 2113. The support portions 2114 and 2115 are two portions that form a part of the U-shaped portion of the housing 2111. The support potion 2114 includes an annular portion 2116 in which the drive unit 2150 is disposed. The support portion 2115 includes an annular portion 2117 in which the drive unit 2150 is disposed.

As illustrated in FIG. 28, the drive unit 2150 is moved in a left direction in FIG. 28 to pass through an opening of the annular portion 2116 of the support potion 2114, and the drive unit 2150 is disposed between the pair of support portions 2114 and 2115. Then, a flange portion 1613 of a positioning member 161 is fixed to the annular portion 2116 formed by the support portion 2114 and the base portion 2113 by a fastening member (not illustrated). Further, the coupling member 183 is fitted to the outer ring 1531 of the bearing 153 of the drive unit 2150, and the coupling member 183 is fixed to the annular portion 2117 formed by the support portion 2115 and the base portion 2113 by a fastening member 182. At this time, the coupling member 183 and the outer ring 1531 of the bearing 153 are preferably fitted by transition fitting or interference fitting. The drive structure 2400 can be assembled by fixing the wheel 2120 to the wheel shaft 2112 by a fastening member 184.

The coupling member 183 and the components inside the drive unit 2150 can be manufactured by a general-purpose machine similarly to of the robot of the first embodiment described above, and the motor 151, the speed reducer 152, and the bearing 153 can be assembled to each other with high assembly accuracy. Therefore, the drive unit 2150 can be assembled with high accuracy, and the drive unit 2150 can function as a drive device with compensated accuracy.

On the other hand, the pair of support portions 2114 and 2115 of the housing 2111 do not need to have a highly accurate positional relationship with each other as in the comparative example. That is, parallelism of the pair of support portions 2114 and 2115 and coaxiality and size tolerance (fitting tolerance) of the annular portions 2116 and 2117 in which the drive unit 2150 is disposed do not need to be as highly accurate as the drive unit 2150. Since the accuracy of the drive device is compensated by the drive unit 2150, the drive unit 2150 can be installed in the U-shaped portion of the housing 2111 to function as the drive device. A relative position error between the two support portions 2114 and 2115 is absorbed by an allowable inclination, an internal gap, or a fitting gap of the bearing 153 itself.

As described above, in the second embodiment, the motor 151, the speed reducer 152, and the bearing 153 can be axially aligned when the drive unit 2150 is assembled, and it is not necessary to perform axial alignment unlike the comparative example. Therefore, it is not necessary to increase the size and weight unlike the comparative example, the housing 2111 can be reduced in size and weight, and the motor 151, the speed reducer 152, and the bearing 153 can be axially aligned with high accuracy. Therefore, frictional resistance can be reduced. In the second embodiment, the housing 2111 is integrally molded. Therefore, it is possible to reduce the size and weight of the housing 2111 while securing stiffness necessary for the housing 2111. Then, it is sufficient if the drive unit 2150 including the motor 151, the speed reducer 152, and the bearing 153 that are axially aligned is attached to the housing 2111. As the motor 151, the speed reducer 152, and the bearing 153 are axially aligned, performance and durability of the motor 151, the speed reducer 152, and the bearing 153 can be improved. In addition, frictional resistance caused by axial misalignment of the motor 151, the speed reducer 152, and the bearing 153 can be reduced, and positioning control and speed control of two or more wheels provided in an automobile can be performed with high accuracy. That is, it is possible to perform a highly accurate and highly efficient driving operation.

### Third Embodiment

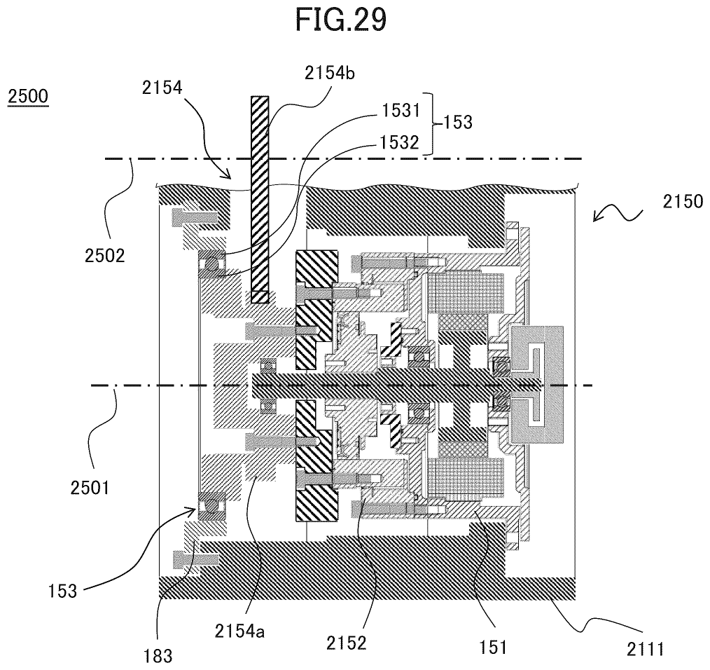

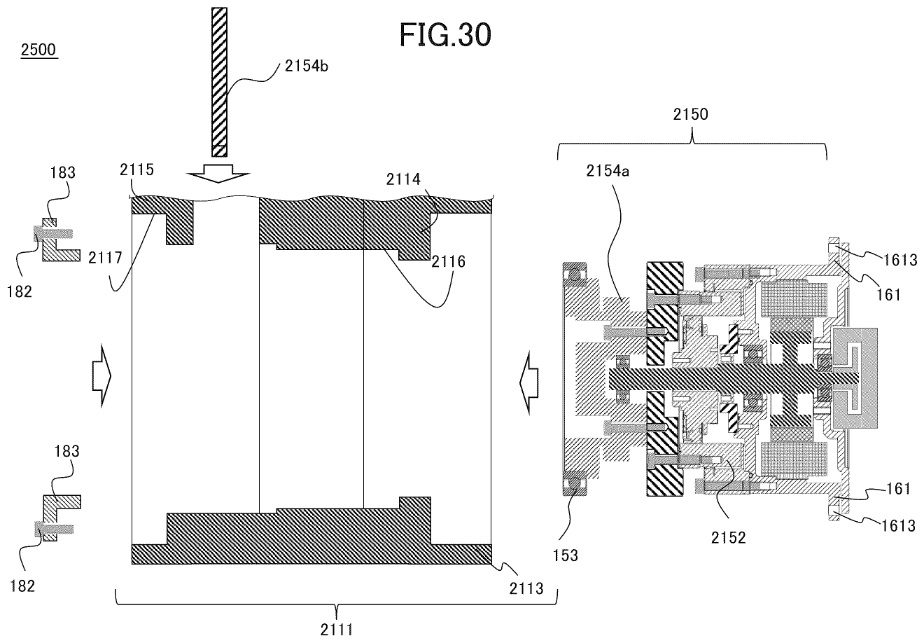

Next, a third embodiment will be described in detail. In the second embodiment described above, a serial drive mechanism has been described as an example. The present disclosure is also applicable to a parallel drive mechanism. In the third embodiment, an electric vehicle will be described as an example. FIG. 29 is an explanatory view of a drive structure 2500 of an automobile according to the third embodiment, the drive structure 2500 including a motor and a wheel. FIG. 30 is an explanatory view of a method of assembling the drive structure 2500 of the automobile according to the third embodiment, the drive structure 2500 including the motor and the wheel. In the following, the same reference numerals will be used for the same or corresponding configurations as those of the first and second embodiments, and a description thereof is omitted or simplified, and differences from the first and second embodiments will be mainly described.

As illustrated in FIG. 29, in the parallel drive structure 2500 of the third embodiment, a shaft 2501 of a motor 151 and a wheel shaft 2502 are not aligned with each other. In general, power of a motor is transmitted to a wheel via a speed reducer. As the speed reducer, a gear train, a belt, a chain, or the like is used. The drive structure 2500 of the third embodiment includes a housing 2111, a drive unit 2150, and a wheel (not illustrated). The housing 2111 is an example of the support. The drive unit 2150 is supported by the housing 2111. The drive unit 2150 includes the motor 151, a first speed reducer 2152, and a bearing 153. The motor 151 is provided on an input side of the first speed reducer 2152, and the bearing 153 is provided on an output side of the first speed reducer 2152. An input gear 2154a is formed on an output shaft of the first speed reducer 2152 and is engaged with an output gear 2154b provided on the wheel to form a second speed reducer 2154.

Referring to FIG. 29, the motor 151 drives the wheel (tire) (not illustrated) via the first speed reducer 2152 and the second speed reducer 2154. The bearing 153 is disposed between the housing 2111 and the drive unit 2150. As in the second embodiment, an outer ring 1531 of the bearing 153 is connected to a coupling member 183 and is provided in the housing 2111 via the coupling member 183. An inner ring 1532 of the bearing 153 is connected to the input gear 2154a that receives an output from the first speed reducer 2152. The motor 151, the first speed reducer 2152, and the bearing 153 become frictional resistance when axes thereof are misaligned from each other. Therefore, in order to perform highly efficient driving, it is required to position the motor 151, the first speed reducer 2152, and the bearing 153 with high accuracy, that is, to align the axes of the motor 151, the first speed reducer 2152, and the bearing 153 with each other.

The housing 2111 has an opening portion through which the second speed reducer 2154 passes, and has a substantially U-shaped portion (see FIG. 30). The drive unit 2150 is disposed in the U-shaped portion. In the third embodiment, the drive unit 2150 is mounted on the U-shaped portion so as to be integrally detachable from the U-shaped portion of the housing 2111. In other words, the drive unit 2150 is unitized, that is, integrated, and attached to the housing 2111 so as to be detachable from the housing 2111 in an integrated state.

Next, the method of assembling the drive structure 2500 according to the third embodiment will be described with reference to FIG. 30. Similarly to the above-described second embodiment, the housing 2111 that is the support includes a base portion 2113 and a pair of support portions 2114 and 2115 spaced apart from the base portion 2113. The support portions 2114 and 2115 are two portions that form a part of the U-shaped portion of the housing 2111. The support potion 2114 includes an annular portion 2116 in which the drive unit 2150 is disposed. The support portion 2115 includes an annular portion 2117 in which the drive unit 2150 is disposed.

As illustrated in FIG. 30, the drive unit 2150 is moved in a left direction in FIG. 30 to pass through an opening of the annular portion 2116 of the support potion 2114, and the drive unit 2150 is disposed between the pair of support portions 2114 and 2115. Then, a flange portion 1613 of a positioning member 161 is fixed to the annular portion 2116 formed by the support portion 2114 and the base portion 2113 by a fastening member (not illustrated). Further, the coupling member 183 is fitted to the outer ring 1531 of the bearing 153 of the drive unit 2150, and the coupling member 183 is fixed to the annular portion 2117 formed by the support portion 2115 and the base portion 2113 by a fastening member 182. The input gear 2154a functions as a positioning member that positions the bearing 153 with respect to the drive unit 2150. At this time, the coupling member 183 and the outer ring 1531 of the bearing 153 are preferably fitted by transition fitting or interference fitting. Then, the drive structure 2500 can be assembled by engaging the output gear 2154b with the input gear 2154a.

The coupling member 183 and the components inside the drive unit 2150 can be manufactured by a general-purpose machine similarly to of the robot of the first embodiment described above, and the motor 151, the first speed reducer 2152, and the bearing 153 can be assembled to each other with high assembly accuracy. Therefore, the drive unit 2150 can be assembled with high accuracy, and the drive unit 2150 can function as a drive device with compensated accuracy.

On the other hand, the pair of support portions 2114 and 2115 of the housing 2111 do not need to have a highly accurate positional relationship with each other as in the comparative example. That is, parallelism of the pair of support portions 2114 and 2115 and coaxiality and size tolerance (fitting tolerance) of the annular portions 2116 and 2117 in which the drive unit 2150 is disposed do not need to be as highly accurate as the drive unit 2150. Since the accuracy of the drive device is compensated by the drive unit 2150, the drive unit 2150 can be installed in the U-shaped portion of the housing 2111 to function as the drive device. A relative position error between the two support portions 2114 and 2115 is absorbed by an allowable inclination, an internal gap, or a fitting gap of the bearing 153 itself.

As described above, in the third embodiment, the motor 151, the first speed reducer 2152, and the bearing 153 can be axially aligned when the drive unit 2150 is assembled, and it is not necessary to perform axial alignment unlike the comparative example. Therefore, it is not necessary to increase the size and weight unlike the comparative example, the housing 2111 can be reduced in size and weight, and the motor 151, the speed reducer 152, and the bearing 153 can be axially aligned with high accuracy. Therefore, frictional resistance can be reduced. In the third embodiment, the housing 2111 is integrally molded. Therefore, it is possible to reduce the size and weight of the housing 2111 while securing stiffness necessary for the housing 2111. Then, it is sufficient if the drive unit 2150 including the motor 151, the first speed reducer 2152, and the bearing 153 that are axially aligned is attached to the housing 2111. As the motor 151, the first speed reducer 2152, and the bearing 153 are axially aligned, performance and durability of the motor 151, the first speed reducer 2152, and the bearing 153 can be improved. In addition, frictional resistance caused by axial misalignment of the motor 151, the first speed reducer 2152, and the bearing 153 can be reduced, and positioning control and speed control of two or more wheels provided in an automobile can be performed with high accuracy. That is, it is possible to perform a highly accurate and highly efficient driving operation.

As described above, according to the present disclosure, it is possible to improve accuracy of the operation executed by the apparatus.

### Other Modified Examples

Note that the present disclosure is not limited to the embodiments described above, and many modifications can be made within the technical idea of the present disclosure. For example, at least two of the above-described embodiments and the plurality of modified examples may be combined. In addition, the effects described in the present embodiment merely enumerate the most preferable effects that result from the embodiment of the present disclosure, and the effects of the embodiments of the present disclosure are not limited to those described in the present embodiment.

In the first embodiment described above, a mode in which the proximal end side link 111 is provided on a fixed side (input side) of the speed reducer and the distal end side link 112 is provided on a rotation side (output side) of the speed reducer has been described as an example. However, depending on how the speed reducer is fixed, a member on the output side of the speed reducer (for example, circular spline) may be fixed to the link 111, and a member on the input side of the speed reducer (for example, flex spline) may be provided on a member that outputs rotation to form a joint. In this way, the link 112 can be provided on the fixed side (input side) of the speed reducer, and the link 111 can be provided on the rotation side (output side) of the speed reducer.

In the above-described first embodiment, a case where the robot is a vertical articulated robot has been described, but the present technology is not limited thereto. The robot may be, for example, a horizontal articulated robot, a parallel linked robot, or an orthogonal robot. The present disclosure can be applied to a machine capable of automatically performing an operation of expansion and contraction, bending and stretching, vertical movement, horizontal movement, or turning, or a combined operation thereof based on information of the storage device provided in the control device.

In the first embodiment and the plurality of modified examples described above, the joint J2 among the plurality of joints has been described, but the present technology is not limited thereto. The joint structure of any one of the first embodiment and the plurality of modified examples described above may be applied to a joint other than the joint J2.

In the first embodiment and the plurality of modified examples described above, a case where the outer ring 1531 of the inner ring 1532 and the outer ring 1531 of the bearing 153 is supported by the positioning member 162 and the inner ring 1532 is supported by the support portion 1112 of the link 111 has been described. However, the present technology is not limited thereto, and although not illustrated, the inner ring 1532 of the inner ring 1532 and the outer ring 1531 of the bearing 153 may be supported by the positioning member 162 and the outer ring 1531 may be supported by the support portion 1112 of the link 111. That is, one of the inner ring 1532 and the outer ring 1531 of the bearing 153 may be supported by the positioning member 162, and the other may be supported by the support portion 1112 of the link 111.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-114780, filed Jul. 12, 2023, and Japanese Patent Application No. 2024-092622, filed Jun. 6, 2024, which are hereby incorporated by reference herein in their entirety.

What is claimed is:

1. An apparatus comprising:
a support having two portions; and
a unit including a speed reducer, a motor provided on the speed reducer, and a bearing provided on the speed reducer, the speed reducer, the motor, and the bearing being integrally assembled with each other and mounted on the two portions.

2. The apparatus according to claim 1, wherein
the two portions are a part of a U-shaped portion, and the support has the U-shaped portion.

3. The apparatus according to claim 1, wherein
the unit is mounted on the support so as to be integrally detachable from the support.

4. The apparatus according to claim 2, wherein
the unit includes a first member configured to position the motor and the speed reducer.

5. The apparatus according to claim 4, wherein
the first member includes a housing configured to house a stator and a rotor of the motor.

6. The apparatus according to claim 4, wherein
the unit includes a first oil seal provided on an input side of the speed reducer and supported by the first member.

7. The apparatus according to claim 4, wherein
the first member is supported by the U-shaped portion.

8. The apparatus according to claim 1, further comprising
a second member configured to integrate the bearing into the unit and position the bearing in the unit.

9. The apparatus according to claim 8, wherein
one of an inner ring and an outer ring of the bearing is supported by the second member, and the other is supported by the support.

10. The apparatus according to claim 9, wherein
the other of the inner ring and the outer ring of the bearing is fixed to the support via a coupling member.

11. The apparatus according to claim 8, wherein
the unit includes a second oil seal provided on an output side of the speed reducer and supported by the second member.

12. The apparatus according to claim 8, wherein
the second member is fixed to an output side of the speed reducer, and positions the speed reducer and the bearing.

13. The apparatus according to claim 12, wherein
the second member is fixed to the output side of the speed reducer by a plurality of fastening members arranged in a circumferential direction, and
a diameter of an imaginary circle passing through centers of the plurality of fastening members is smaller than an outer diameter of the bearing.

14. The apparatus according to claim 2, wherein
the unit includes a brake.

15. The apparatus according to claim 2, wherein
the unit includes an encoder.

16. The apparatus according to claim 2, wherein
the U-shaped portion includes a base portion and a pair of support portions disposed on the base portion while being spaced apart from each other in a predetermined direction,
the support portions are the two portions, and
the unit is supported by the pair of support portions.

17. The apparatus according to claim 16, wherein
each of the pair of support portions includes an annular portion to which the unit is fixed.

18. The apparatus according to claim 16, wherein
the pair of support portions are integrally molded with the base portion.

19. The apparatus according to claim 18, wherein
each of the pair of support portions has a draft angle.

20. The apparatus according to claim 19, wherein
the draft angle increases as a distance from the base portion increases.

21. The apparatus according to claim 19, wherein
the draft angle increases as a distance from a center of the support portion increases in a direction parallel to the base portion.

22. The apparatus according to claim 16, wherein
the pair of support portions are fastened to the base portion by fastening members in a direction intersecting the predetermined direction.

23. The apparatus according to claim 1, wherein
the support is a first link, and
the apparatus further includes a second link supported by the unit so as to be rotationally driven by the unit with respect to the first link.

24. The apparatus according to claim 23, further comprising
a force sensor disposed between the unit and the second link.

25. The apparatus according to claim 23, further comprising
a force sensor disposed between the unit and the first link.

26. A robot that is the apparatus according to claim 1.

27. An automobile that is the apparatus according to claim 1.

28. An apparatus control method comprising:
controlling the apparatus according to claim 1.

29. An article manufacturing method comprising: manufacturing an article by using the robot according to claim 26.

30. A method of assembling an apparatus including a support having two portions, the method comprising:
fixing a speed reducer and a motor to a first member such that the speed reducer and the motor are positioned;
fixing the speed reducer and a bearing to a second member such that the speed reducer and the bearing are positioned; and
supporting the first member and the bearing by the two portions of the support.

31. A non-transitory computer-readable recording medium recording a program for causing a computer to execute the control method according to claim 28.
